(19) United States
(12) Patent Application Publication
(10) Pub. No.: US 2024/0084116 A1
(43) Pub. Date: Mar. 14, 2024

(54) THERMOPLASTIC COMPOSITIONS COMPRISING BIMODAL POLYETHYLENE AND ARTICLES MANUFACTURED THEREFROM

(71) Applicant: Dow Global Technologies LLC, Midland, MI (US)

(72) Inventors: Mohamed Esseghir, Lawrenceville, NJ (US); Theo Geussens, Samstagern (CH); Andrew T. Heitsch, Angleton, TX (US); Karl M. Seven, Auburn, PA (US); Stephanie M. Whited, Charleston, WV (US); Lalit A. Darunte, Charleston, WV (US); Mridula Kapur, Lake Jackson, TX (US); John P. O'Brien, Manvel, TX (US)

(73) Assignee: Dow Global Technologies LLC, Midland, MI (US)

(21) Appl. No.: 18/263,409

(22) PCT Filed: Jan. 27, 2022
(86) PCT No.: PCT/US2022/014076

§ 371 Date: Jul. 28, 2023

Related U.S. Application Data
(60) Provisional application No. 63/143,128, filed on Jan. 29, 2021.

(51) Int. Cl. C08L 23/08; C08F 2/34; C08F 4/659; C08F 10/02; C08K 3/04

(52) U.S. Cl. CPC C08L 23/0815; C08F 2/34; C08F 4/65912; C08F 10/02; C08K 3/04; C08L 2203/206; C08L 2314/02

(57) ABSTRACT

In various embodiments, a bimodal polyethylene may include a high molecular weight component and a low molecular weight component. The bimodal polyethylene may have a density of from 0.933 g/cm³ to 0.960 g/cm³, a melt index (I₂) of from 0.3 dg/min to 1.2 dg/min, and a melt flow ratio (MFR₂₁) greater than 70.0. The high molecular weight component may have a density of from 0.917 g/cm³ to 0.929 g/cm³, and a high load melt index (I₂₁) of from 0.85 dg/min to 4.00 dg/min. The bimodal polyethylene may include from 40 wt. % to 60 wt % of the high molecular weight component. Methods for producing the bimodal polyethylene and articles manufactured from the bimodal polyethylene are also provided.

### TECHNICAL FIELD

Embodiments of the present disclosure are generally directed to thermoplastic compositions and, in particular, thermoplastic compositions comprising bimodal polyethylene and articles manufactured therefrom.

### BACKGROUND

When manufacturing insulation and jacket layers for wires and cables, both the performance (e.g., mechanical properties, environmental stress-cracking resistance, etc.) and the processability of the thermoplastic compositions used for the manufacture of the insulation and jacket layers are critical in order to ensure both success in fabrication and long-term durability during service. While some thermoplastic compositions may have superior mechanical properties, such as elongation at break, these superior mechanical properties are typically achieved by sacrificing processability, environmental stress-cracking resistance, or both. In contrast, other thermoplastic compositions may achieve superior processability by sacrificing mechanical properties, environmental stress-cracking resistance, or both. Accordingly, there is an ongoing need for thermoplastic compositions that balance mechanical properties and processability while also maintaining environmental stress-cracking resistance.

### SUMMARY

Embodiments of the present disclosure address these needs by providing a bimodal polyethylene comprising a high molecular weight component and a low molecular weight component. In some embodiments, the bimodal polyethylene has a density of from 0.933 grams per centimeter (g/cm³) to 0.960 g/cm³, a melt index (I₂) of from 0.3 decigrams per minute (dg/min) to 0.9 dg/min, and a melt flow ratio (MFR₂₁) greater than or equal to 70.0. In some embodiments, the high molecular weight component has a density of from 0.917 g/cm³ to 0.927 g/cm³, and a high load melt index (I₂₁) of from 0.85 dg/min to 4.00 dg/min. In some embodiments, the bimodal polyethylene includes from 40 weight percent (wt. %) to 60 wt. % of the high molecular weight component.

These and additional features provided by the embodiments of the present disclosure will be more fully understood in view of the following detailed description.

### DETAILED DESCRIPTION

As noted previously, when manufacturing insulation and jacket layers for wires and cables, both the performance (e.g., mechanical properties, environmental stress-cracking resistance, etc.) and the processability of the thermoplastic compositions used for the manufacture of the insulation and jacket layers are critical in order to ensure both success in fabrication and long-term durability during service. Typically, high-density polyethylene is used to produce thermoplastic compositions in order to achieve insulation and jacket layers with improved mechanical properties and, as a result, improved abrasion resistance for durability and a reduced coefficient of friction for ease of installation. However, polyethylene with high density generally results in insulation and jacket layers with poor environmental stress-cracking resistance, which leads to brittle failure of the insulation and jacket layers. While reducing the density, melt index, and high load melt index of the polyethylene may improve the environmental stress-cracking resistance of the insulation and jacket layers, this may also reduce the mechanical properties of the insulation and jacket layers, and processability of the polyethylene.

Embodiments of the present disclosure are directed to bimodal polyethylene that provide superior processability, while also achieving significant mechanical properties and environmental stress-cracking resistance. In particular, embodiments of the present disclosure are directed to bimodal polyethylene comprising a high molecular weight component and a low molecular weight component. The bimodal polyethylene may have a density of from 0.933 g/cm³ to 0.960 g/cm³, a melt index (I₂) of from 0.3 dg/min to 1.2 dg/min, and a melt flow ratio (MFR₂₁) greater than 70.0. The high molecular weight component may have a density of from 0.917 g/cm³ to 0.929 g/cm³, and a high load melt index (I₂₁) of from 0.85 dg/min to 4.00 dg/min. The bimodal polyethylene may include from 40 wt. % to 60 wt % of the high molecular weight component.

The term “polymer” refers to polymeric compounds prepared by polymerizing monomers, whether of the same or a different type. Accordingly, the generic term polymer includes homopolymers, which are polymers prepared by polymerizing only one monomer, and copolymers, which are polymers prepared by polymerizing two or more different monomers.

The term “interpolymer” refers to polymers prepared by polymerizing at least two different types of monomers. Accordingly, the generic term interpolymer includes copolymers and other polymers prepared by polymerizing more than two different monomers, such as terpolymers.

The term “unimodal polymer” refers to polymers that can be characterized by having only one fraction with a common density, weight average molecular weight, and, optionally, melt index value. Unimodal polymers can also be characterized by having only one distinct peak in a gel permeation chromatography (GPC) chromatogram depicting the molecular weight distribution of the composition.

The term “multimodal polymer” refers to polymers that can be characterized by having at least two fractions with varying densities, weight averaged molecular weights, and, optionally, melt index values. Multimodal polymers can also be characterized by having at least two distinct peaks in a gel permeation chromatography (GPC) chromatogram depicting the molecular weight distribution of the composition. Accordingly, the generic term multimodal polymer includes bimodal polymers, which have two primary fractions: a first fraction, which may be a low molecular weight fraction and/or component, and a second fraction, which may be a high molecular weight fraction and/or component.

The terms “polyolefin.” “polyolefin polymer,” and “polyolefin resin” refer to polymers prepared by polymerizing a simple olefin (also referred to as an alkene, which has the general formula CₙH₂ₙ) monomer. Accordingly, the generic term polyolefin includes polymers prepared by polymerizing ethylene monomer with or without one or more comonomers, such as polyethylene, and polymers prepared by polymerizing propylene monomer with or without one or more comonomers, such as polypropylene.

The terms “polyethylene” and “ethylene-based polymer” refer to polyolefins comprising greater than 50 percent (%) by mole of units that have been derived from ethylene monomer, which includes polyethylene homopolymers and copolymers. Common forms of polyethylene known in the art include Low Density Polyethylene (LDPE), Linear Low Density Polyethylene (LLDPE), Ultra Low Density Polyethylene (ULDPE), Very Low Density Polyethylene (VLDPE), Medium Density Polyethylene (MDPE), and High Density Polyethylene (HDPE).

The term “melt flow ratio” refers to a ratio of melt indices of a polymer. Accordingly, the generic term melt flow ratio includes a ratio of a high load metal index (I₂) of a polymer to a melt index (I₂) of the polymer, which may also be referred to as an “MFR₂₁.”

The term “shear thinning index” refers to a ratio of complex viscosities of a polymer. Accordingly, the generic term shear thinning index includes a ratio of a complex viscosity of a polymer at a frequency of 0.1 radians per second (rad/s) to a ratio of a complex viscosity of the polymer at a frequency of 100 rad/s.

The term “composition” refers to a mixture of materials that comprises the composition, as well as reaction products and decomposition products formed from the materials of the composition.

The terms “comprising,” “including,” “having,” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed.

In one or more embodiments, the bimodal polyethylene has a density of from 0.933 g/cm³ to 0.960 g/cm³. For example, the bimodal polyethylene may have a density of from 0.933 g/cm³ to 0.957 g/cm³, from 0.933 g/cm³ to 0.954 g/cm³, from 0.933 g/cm³ to 0.951 g/cm³, from 0.933 g/cm³ to 0.948 g/cm³, from 0.933 g/cm³ to 0.945 g/cm³, from 0.933 g/cm³ to 0.942 g/cm³, from 0.933 g/cm³ to 0.9390 g/cm³, from 0.933 g/cm³ to 0.936 g/cm³, from 0.936 g/cm³ to 0.960 g/cm³, from 0.936 g/cm³ to 0.957 g/cm³, from 0.936 g/cm³ to 0.954 g/cm³, from 0.936 g/cm³ to 0.951 g/cm³, from 0.936 g/cm³ to 0.948 g/cm³, from 0.936 g/cm³ to 0.945 g/cm³, from 0.936 g/cm³ to 0.942 g/cm³, from 0.936 g/cm³ to 0.939 g/cm³, from 0.939 g/cm³ to 0.960 g/cm³, from 0.939 g/cm³ to 0.957 g/cm³, from 0.939 g/cm³ to 0.954 g/cm³, from 0.939 g/cm³ to 0.951 g/cm³, from 0.939 g/cm³ to 0.948 g/cm³, from 0.939 g/cm³ to 0.945 g/cm³, from 0.939 g/cm³ to 0.942 g/cm³, from 0.942 g/cm³ to 0.960 g/cm³, from 0.942 g/cm³ to 0.957 g/cm³, from 0.942 g/cm³ to 0.954 g/cm³, from 0.942 g/cm³ to 0.951 g/cm³, from 0.942 g/cm³ to 0.948 g/cm³, from 0.942 g/cm³ to 0.945 g/cm³, from 0.945 g/cm³ to 0.960 g/cm³, from 0.945 g/cm³ to 0.957 g/cm³, from 0.945 g/cm³ to 0.954 g/cm³, from 0.945 g/cm³ to 0.951 g/cm³, from 0.945 g/cm³ to 0.948 g/cm³, from 0.948 g/cm³ to 0.960 g/cm³, from 0.948 g/cm³ to 0.957 g/cm³, from 0.948 g/cm³ to 0.954 g/cm³, from 0.948 g/cm³ to 0.951 g/cm³, from 0.951 g/cm³ to 0.960 g/cm³, from 0.951 g/cm³ to 0.957 g/cm³, from 0.951 g/cm³ to 0.954 g/cm³, from 0.954 g/cm³ to 0.960 g/cm³, from 0.954 g/cm³ to 0.957 g/cm³, or from 0.957 g/cm³ to 0.960 g/cm³. As noted previously, when the density of the bimodal polyethylene is greater than, for example, 0.960 g/cm³, articles manufactured from the bimodal polyethylene may have poor environmental stress-cracking resistance, which leads to brittle failure of the insulation and jacket layers. In contrast, when the density of the bimodal polyethylene is less than, for example, 0.933 g/cm³, the mechanical properties of the articles, as well as the processability of the bimodal polyethylene may be reduced.

In one or more embodiments, the bimodal polyethylene has a melt index (I₂) of from 0.3 dg/min to 0.9 dg/min. For example, the bimodal polyethylene may have a melt index (I₂) of from 0.3 dg/min to 0.8 dg/min, from 0.3 dg/min to 0.7 dg/min, from 0.3 dg/min to 0.6 dg/min, from 0.3 dg/min to 0.5 dg/min, from 0.3 dg/min to 0.4 dg/min, from 0.4 dg/min to 0.9 dg/min. from 0.4 dg/min to 0.8 dg/min, from 0.4 dg/min to 0.7 dg/min, from 0.4 dg/min to 0.6 dg/min, from 0.4 dg/min to 0.5 dg/min, from 0.5 dg/min to 0.9 dg/min, from 0.5 dg/min to 0.8 dg/min, from 0.5 dg/min to 0.7 dg/min, from 0.5 dg/min to 0.6 dg/min, from 0.6 dg/min to 0.9 dg/min, from 0.6 dg/min to 0.8 dg/min, from 0.6 dg/min to 0.7 dg/min, from 0.7 dg/min to 0.9 dg/min, from 0.7 dg/min to 0.8 dg/min, or from 0.8 dg/min to 0.9 dg/min.

In one or more embodiments, the bimodal polyethylene has a high load melt index (I₂₁) greater than or equal to 35.0 dg/min, such as greater than or equal to 45.0 dg/min, greater than or equal to 55.0 dg/min, or greater than or equal to 65.0 dg/min. In some embodiments, the bimodal polyethylene has a high load melt index (I₂₁) less than or equal to 75.0 dg/min, such as less than or equal to 65.0 dg/min, less than or equal to 55.0 dg/min, or less than or equal to 45.0 dg/min. For example, the bimodal polyethylene may have a high load melt index (I₂₁) of from 35.0 dg/min to 75.0 dg/min, from 35.0 dg/min to 65.0 dg/min, from 35.0 dg/min to 55.0 dg/min, from 35.0 dg/min to 45.0 dg/min, from 45.0 dg/min to 75.0 dg/min, from 45.0 dg/min to 65.0 dg/min, from 45.0 dg/min to 55.0 dg/min, from 55.0 dg/min to 75.0 dg/min, from 55.0 dg/min to 65.0 dg/min, or from 65.0 dg/min to 75.0 dg/min.

In one or more embodiments, the bimodal polyethylene has a melt flow ratio (MFR₂₁) greater than or equal to 70.0, such as greater than or equal to 80.0, greater than or equal to 90.0, or greater than or equal to 100.0. In some embodiments, the bimodal polyethylene has a melt flow ratio (MFR₂₁) less than or equal to 130.0, such as less than or equal to 120.0, less than or equal to 110.0, or less than or equal to 100.0. For example, the bimodal polyethylene may have a melt flow ratio (MFR₂₁) of from 70.0 to 130.0, from 70.0 to 120.0, from 70.0 to 110.0, from 70.0 to 100.0, from 70.0 to 90.0, from 70.0 to 80.0, from 80.0 to 130.0, from 80.0 to 120.0, from 80.0 to 110.0, from 80.0 to 100.0, from 80.0 to 90.0, from 90.0 to 130.0, from 90.0 to 120.0, from 90.0 to 110.0, from 90.0 to 100.0, from 100.0 to 130.0, from 100.0 to 120.0, from 100.0 to 110.0, from 110.0 to 130.0, from 110.0 to 120.0, or from 120.0 to 130.0. When the melt flow ratio (MFR₂₁) of the bimodal polyethylene is less than, for example, 70.0, thermoplastic compositions including the bimodal polyethylene may not have adequate processability to manufacture articles, such as, for example, insulation and jacket layers for wires and cables. Moreover, when the melt flow ratio (MFR₂₁) of the bimodal polyethylene is less than, for example, 70.0, insulation and jacket layers including the bimodal polyethylene may not have wire smoothness values necessary for some applications.

In one or more embodiments, the bimodal polyethylene has a number average molecular weight (M_{n(GPC)}) greater than or equal to 5,000 g/mol, such as greater than or equal to 7,500 g/mol, greater than or equal to 10,000 g/mol, or greater than or equal to 12,500 g/mol. In some embodiments, the bimodal polyethylene has a number average molecular weight (M_{n(GPC)}) less than or equal to 30,000 g/mol, such as less than or equal to 27,500 g/mol, less than or equal to 25,000 g/mol, or less than or equal to 22,500 g/mol. For example, the bimodal polyethylene may have a number average molecular weight (M_{n(GPC)}) of from 5,000 g/mol to 30,000 g/mol, from 5,000 g/mol to 27,500 g/mol, from 5,000 g/mol to 25,000 g/mol, from 5000 g/mol to 22,500 g/mol, from 5,000 g/mol to 20,000 g/mol, from 5,000 g/mol to 17,500 g/mol, from 5,000 g/mol to 15,000 g/mol, from 5,000 g/mol to 12,500 g/mol, from 5,000 g/mol to 10,000 g/mol, from 10,000 g/mol to 30,000 g/mol, from 10,000 g/mol to 27,500 g/mol, from 10,000 g/mol to 25,000 g/mol, from 10,000 g/mol to 22,500 g/mol, from 10,000 g/mol to 20,000 g/mol, from 10,000 g/mol to 17,500 g/mol, from 10,000 g/mol to 15,000 g/mol, from 10,000 g/mol to 12,500 g/mol, from 12,500 g/mol to 30,000 g/mol, from 12,500 g/mol to 27,500 g/mol, from 12,500 g/mol to 25,000 g/mol, from 12,500 g/mol to 22,500 g/mol, from 12,500 g/mol to 20,000 g/mol, from 12,500 g/mol to 17,500 g/mol, from 12,500 g/mol to 15,000 g/mol, from 15,000 g/mol to 30,000 g/mol, from 15,000 g/mol to 27,500 g/mol, from 15,000 g/mol to 25,000 g/mol, from 15,000 g/mol to 22,500 g/mol, from 15,000 g/mol to 20,000 g/mol, from 15,000 g/mol to 17,500 g/mol, from 17,500 g/mol to 30,000 g/mol, from 17,500 g/mol to 27,500 g/mol, from 17,500 g/mol to 25,000 g/mol, from 17,500 g/mol to 22,500 g/mol, from 17,500 g/mol to 20,000 g/mol, from 20,000 g/mol to 30,000 g/mol, from 20,000 g/mol to 27,500 g/mol, from 20,000 g/mol to 25,000 g/mol, from 20,000 g/mol to 22,500 g/mol, from 22,500 g/mol to 30,000 g/mol, from 22,500 g/mol to 27,500 g/mol, from 22,500 g/mol to 25,000 g/mol, from 25,000 g/mol to 30,000 g/mol, from 25,000 g/mol to 27,500 g/mol, or from 27.500 g/mol to 30,000 g/mol.

In one or more embodiments, the bimodal polyethylene has a weight average molecular weight (M_{w(GPC)}) greater than or equal to 100,000 g/mol, such as greater than or equal to 125,000 g/mol, greater than or equal to 150,000 g/mol, or greater than or equal to 175,000 g/mol. In some embodiments, the bimodal polyethylene has a weight average molecular weight (M_{w(GPC)}) less than or equal to 250,000 g/mol, such as less than or equal to 225,000 g/mol, less than or equal to 200,000 g/mol, or less than or equal to 175,000 g/mol. For example, the bimodal polyethylene may have a weight average molecular weight (M_{w(GPC)}) of from 100,000 g/mol to 250,000 g/mol, from 100,000 g/mol to 225,000 g/mol, from 100,000 g/mol to 200,000 g/mol, from 100,000 g/mol to 175,000 g/mol, from 100,000 g/mol to 150,000 g/mol, from 100,000 g/mol to 125,000 g/mol, from 125,000 g/mol to 250,000 g/mol, from 125,000 g/mol to 225,000 g/mol, from 125,000 g/mol to 200,000 g/mol, from 125,000 g/mol to 175,000 g/mol, from 125,000 g/mol to 150,000 g/mol, from 150,000 g/mol to 250,000 g/mol, from 150,000 g/mol to 225,000 g/mol, from 150,000 g/mol to 200,000 g/mol, from 150,000 g/mol to 175,000 g/mol, from 175,000 g/mol to 250,000 g/mol, from 175,000 g/mol to 225,000 g/mol, from 175,000 g/mol to 200,000 g/mol, from 200,000 g/mol to 250,000 g/mol, from 200,000 g/mol to 225,000 g/mol, or from 225,000 g/mol to 250,000 g/mol.

In one or more embodiments, the bimodal polyethylene has a z-average molecular weight (M_{z(GPC)}) greater than or equal to 500,000 g/mol, such as greater than or equal to 700,000 g/mol, greater than or equal to 900,000 g/mol, or greater than or equal to 1,100,000 g/mol. In some embodiments, the bimodal polyethylene has a z-average molecular weight (M_{z(GPC)}) less than or equal to 2,700,000 g/mol, such as less than or equal to 2,500,000 g/mol, less than or equal to 2,300,000 g/mol, or less than or equal to 2,100,000 g/mol. For example, the bimodal polyethylene may have a z-average molecular weight (M_{z(GPC)}) of from 500,000 g/mol to 1,500,000 g/mol, from 500,000 g/mol to 1,300,000 g/mol, from 500,000 g/mol to 1,100,000 g/mol, from 500,000 g/mol to 900,000 g/mol, from 500,000 g/mol to 700,000 g/mol, from 700,000 g/mol to 1,500,000 g/mol, from 700,000 g/mol to 1,300,000 g/mol, from 700,000 g/mol to 1,100,000 g/mol, from 700,000 g/mol to 900,000 g/mol, from 90,000 g/mol to 1,500,000 g/mol, from 900,000 g/mol to 1,300,000 g/mol, from 900,000 g/mol to 1,100,000 g/mol, from 1,100,000 g/mol to 1,500,000 g/mol, from 1,100,000 g/mol to 1,300,000 g/mol, or from 1,300,000 g/mol to 1,500,000 g/mol.

In one or more embodiments, the bimodal polyethylene has a polydispersity (i.e., M_{w(GPC)}/M_{n(GPC)}) greater than or equal to 10, such as greater than or equal to 12, greater than or equal to 14, or greater than or equal to 16. In some embodiments, the bimodal polyethylene has a M_{w(GPC)}/M_{n(GPC)} less than or equal to 20, such as less than or equal to 18, less than or equal to 16, or less than or equal to 14. For example, the bimodal polyethylene may have a M_{w(GPC)}/M_{n(GPC)} of from 10 to 20, from 10 to 18, from 10 to 16, from 10 to 14, from 10 to 12, from 12 to 20, from 12 to 18, from 12 to 16, from 12 to 14, from 14 to 20, from 14 to 18, from 14 to 16, from 16 to 20, from 16 to 18, or from 18 to 20. When the M_{w(GPC)}/M_{n(GPC)} of the bimodal polyethylene is less than, for example, 10, thermoplastic compositions including the bimodal polyethylene may not have adequate processability to manufacture articles, such as, for example, insulation and jacket layers for wires and cables. Moreover, when the r M_{w(GPC)}/M_{n(GPC)} of the bimodal polyethylene is less than, for example, 10, insulation and jacket layers including the bimodal polyethylene may not have wire smoothness values necessary for some applications.

In one or more embodiments, the bimodal polyethylene has a M_{z(GPC)}/M_{w(GPC)} greater than or equal to 4, such as greater than or equal to 6, greater than or equal to 8, or greater than or equal to 10. In some embodiments, the bimodal polyethylene has a M_{z(GPC)}/M_{w(GPC)} less than or equal to 16, such as less than or equal to 14, less than or equal to 12, or less than or equal to 10. For example, the bimodal polyethylene may have a M_{z(GPC)}/M_{w(GPC)} of from 4 to 16, from 4 to 14, from 4 to 12, from 4 to 10, from 4 to 8, from 4 to 6, from 6 to 16, from 6 to 14, from 6 to 12, from 6 to 10, from 6 to 8, from 8 to 16, from 8 to 14, from 8 to 12, from 8 to 10, from 10 to 16, from 10 to 14, from 10 to 12, from 12 to 16, from 12 to 14, or from 14 to 16.

In one or more embodiments, the low molecular weight region of the bimodal polyethylene has a low molecular weight short chain branching distribution (SCBD₁), when measured using gel permeation chromatography (GPC), greater than or equal to 0.1, such as greater than or equal to 0.5, greater than or equal to 3.0, or greater than or equal to 4.0. In some embodiments, the low molecular weight region of the bimodal polyethylene has a low molecular short chain branching distribution (SCBD₁) less than or equal to 11.0, such as less than or equal to 9.0, less than or equal to 8.0, or less than or equal to 7.0. For example, the low molecular weight region of the bimodal polyethylene may have a low molecular weight short chain branching distribution (SCBD₁) of from 0.1 to 11.0, from 0.1 to 9.0, from 0.1 to 8.0, from 0.1 to 7.0, from 0.1 to 6.0, from 0.1 to 5.0, from 0.1 to 4.0, from 0.1 to 3.0, from 0.1 to 2.0, from 0.1 to 1.0, from 0.1 to 0.5, from 0.5 to 11.0, from 0.5 to 9.0, from 0.5 to 8.0, from 0.5 to 7.0, from 0.5 to 6.0, from 0.5 to 5.0, from 0.5 to 4.0, from 0.5 to 3.0, from 0.5 to 2.0, from 0.5 to 1.0, from 1.0 to 11.0, from 1.0 to 9.0, from 1.0 to 8.0, from 1.0 to 7.0, from 1.0 to 6.0, from 1.0 to 5.0, from 1.0 to 4.0, from 1.0 to 3.0, from 1.0 to 2.0, from 2.0 to 11.0, from 2.0 to 9.0, from 2.0 to 8.0, from 2.0 to 7.0, from 2.0 to 6.0, from 2.0 to 5.0, from 2.0 to 4.0, from 2.0 to 3.0, from 3.0 to 11.0, from 3.0 to 9.0, from 3.0 to 8.0, from 3.0 to 7.0, from 3.0 to 6.0, from 3.0 to 5.0, from 3.0 to 4.0, from 4.0 to 11.0, from 4.0 to 9.0, from 4.0 to 8.0, from 4.0 to 7.0, from 4.0 to 6.0, from 4.0 to 5.0, from 5.0 to 11.0, from 5.0 to 9.0, from 5.0 to 8.0, from 5.0 to 7.0, from 5.0 to 6.0, from 6.0 to 11.0, from 6.0 to 9.0, from 6.0 to 8.0, from 6.0 to 7.0, from 7.0 to 11.0, from 7.0 to 9.0, from 7.0 to 8.0, from 8.0 to 11.0, from 8.0 to 9.0, or form 9.0 to 11.0.

In one or more embodiments, the high molecular weight region of the bimodal polyethylene may have a high molecular weight short chain branching distribution (SCBD₂), when measured according to GPC, greater than or equal to 3.0, such as greater than or equal to 4.0, or greater than or equal to 5.0. In some embodiments, the high molecular weight region of the bimodal polyethylene has a high molecular weight short chain branching distribution (SCBD₂) less than or equal to 20.0, such as less than or equal to 19.0, less than or equal to 18.0, or less than or equal to 17.0. For example, the high molecular weight region of the bimodal polyethylene may have a high molecular weight short chain branching distribution (SCBD₂) of from 3.0 to 20.0, from 3.0 to 19.0, from 3.0 to 18.0, from 3.0 to 17.0, from 3.0 to 16.0, from 3.0 to 15.0, from 3.0 to 14.0, from 3.0 to 13.0, from 3.0 to 12.0, from 3.0 to 11.0, from 3.0 to 10.0, from 3.0 to 9.0, from 3.0 to 8.0, from 3.0 to 7.0, from 3.0 to 6.0, from 5.0 to 5.0, from 3.0 to 4.0, from 4.0 to 20.0, from 4.0 to 19.0, from 4.0 to 18.0, from 4.0 to 17.0, from 4.0 to 16.0, from 4.0 to 15.0, from 4.0 to 14.0, from 4.0 to 13.0, from 4.0 to 12.0, from 4.0 to 11.0, from 4.0 to 10.0, from 4.0 to 9.0, from 4.0 to 8.0, from 4.0 to 7.0, from 4.0 to 6.0, from 4.0 to 5.0, from 5.0 to 20.0, from 5.0 to 19.0, from 5.0 to 18.0, from 5.0 to 17.0, from 5.0 to 16.0, from 5.0 to 15.0, from 5.0 to 14.0, from 5.0 to 13.0, from 5.0 to 12.0, from 5.0 to 11.0, from 5.0 to 10.0, from 5.0 to 9.0, from 5.0 to 8.0, from 5.0 to 7.0, from 5.0 to 6.0, from 6.0 to 20.0, from 6.0 to 19.0, from 6.0 to 18.0, from 6.0 to 17.0, from 6.0 to 16.0, from 6.0 to 15.0, from 6.0 to 14.0, from 6.0 to 13.0, from 6.0 to 12.0, from 6.0 to 11.0, from 6.0 to 10.0, from 6.0 to 9.0, from 6.0 to 8.0, from 6.0 to 7.0, from 7.0 to 20.0, from 7.0 to 19.0, from 7.0 to 18.0, from 7.0 to 17.0, from 7.0 to 16.0, from 7.0 to 15.0, from 7.0 to 14.0, from 7.0 to 13.0, from 7.0 to 12.0, from 7.0 to 11.0, from 7.0 to 10.0, from 7.0 to 9.0, from 7.0 to 8.0, from 8.0 to 20.0, from 8.0 to 19.0, from 8.0 to 18.0, from 8.0 to 17.0, from 8.0 to 16.0, from 8.0 to 15.0, from 8.0 to 14.0, from 8.0 to 13.0, from 8.0 to 12.0, from 8.0 to 11.0, from 8.0 to 10.0, from 8.0 to 9.0, from 9.0 to 20.0, from 9.0 to 19.0, from 9.0 to 18.0, from 9.0 to 17.0, from 9.0 to 16.0, from 9.0 to 15.0, from 9.0 to 14.0, from 9.0 to 13.0, from 9.0 to 12.0, from 9.0 to 11.0, from 9.0 to 10.0, from 10.0 to 20.0, from 10.0 to 19.0, from 10.0 to 18.0, from 10.0 to 17.0, from 10.0 to 16.0, from 10.0 to 15.0, from 10.0 to 14.0, from 10.0 to 13.0, from 10.0 to 12.0, from 10.0 to 11.0, from 11.0 to 2.0, from 11.0 to 19.0, from 11.0 to 18.0, from 11.0 to 17.0, from 11.0 to 16.0, from 11.0 to 15.0, from 11.0 to 14.0, from 11.0 to 13.0, from 11.0 to 12.0, from 12.0 to 20.0, from 12.0 to 19.0, from 12.0 to 18.0, from 12.0 to 17.0, from 12.0 to 16.0, from 12.0 to 15.0, from 12.0 to 14.0, from 12.0 to 13.0, from 13.0 to 20.0, from 13.0 to 19.0, from 13.0 to 18.0, from 13.0 to 17.0, from 13.0 to 16.0, from 13.0 to 15.0, from 13.0 to 14.0, from 14.0 to 20.0, from 14.0 to 19.0, from 14.0 to 18.0, from 14.0 to 17.0, from 14.0 to 16.0, from 14.0 to 15.0, from 15.0 to 20.0, from 15.0 to 19.0, from 15.0 to 18.0, from 15.0 to 17.0, from 15.0 to 16.0, from 16.0 to 20.0, from 16.0 to 19.0, from 16.0 to 18.0, from 16.0 to 17.0, from 17.0 to 20.0, from 17.0 to 19.0, from 17.0 to 18.0, from 18.0 to 20.0, from 18.0 to 19.0, or from 19.0 to 20.0.

In one or more embodiments, the bimodal polyethylene has a reverse comonomer distribution. Put more simply, in some embodiments, a ratio of the high molecular weight short chain branching distribution (SCBD₂) to the low molecular weight short chain branching distribution (SCBD₁) (i.e., the comonomer distribution of the bimodal polyethylene) is greater than 1.0. Without being bound by any particular theory, it is believed that bimodal polyethylene having a reverse comonomer distribution may have improved environmental stress cracking resistance (ESCR) and balanced mechanical properties compared to bimodal polyethylene having a normal or flat comonomer distribution.

In one or more embodiments, the complex viscosity of the bimodal polyethylene at 190° C. and a frequency of 0.1 rad/s is greater than or equal to 5,000 Pa·s, such as greater than or equal to 10,000 Pa·s, greater than or equal to 15,000 Pa·s, or greater than or equal to 20,000 Pa·s. In some embodiments, the complex viscosity of the bimodal polyethylene at 190° C. and a frequency of 0.1 rad/s is less than or equal to 35,000 Pa·s, such as less than or equal to 30,000 Pa·s, less than or equal to 25,000 Pa·s, or less than or equal to 20,000 Pa·s. For example, the complex viscosity of the bimodal polyethylene at 190° C. and a frequency of 0.1 rad/s may be from 5,000 Pa·s to 35,000 Pa·s, from 5,000 Pa·s to 30,000 Pa·s, from 5,000 Pa·s to 25,000 Pa·s, from 5,000 Pa·s to 20,000 Pa·s, from 5,000 Pa·s to 15,000 Pa·s, from 5,000 Pa·s to 10,000 Pa·s, from 10,000 Pa·s to 35,000 Pa·s, from 10,000 Pa·s to 30,000 Pa·s, from 10,000 Pa·s to 25,000 Pa·s, from 10,000 Pa·s to 20,000 Pa·s, from 10,000 Pa·s to 15,000 Pa·s, from 15,000 Pa·s to 35,000 Pa·s, from 15,000 Pa·s to 30,000 Pa·s, from 15,000 Pa·s to 25,000 Pa·s, from 15,000 Pa·s to 20,000 Pa·s, from 20,000 Pa·s to 35,000 Pa·s, from 20,000 Pa·s to 30,000 Pa·s, from 20,000 Pa·s to 25,000 Pa·s, from 25,000 Pa·s to 35,000 Pa·s, from 25,000 Pa·s to 30,000 Pa·s, or from 30,000 Pa·s to 35,000 Pa·s.

In one or more embodiments, the complex viscosity of the bimodal polyethylene at 190° C. and a frequency of 1.0 rad/s is greater than or equal to 5,000 Pa·s, such as greater than or equal to 7,500 Pa·s, greater than or equal to 10,000 Pa·s, or greater than or equal to 12,500 Pa·s. In some embodiments, the complex viscosity of the bimodal polyethylene at 190° C. and a frequency of 1.0 rad/s is less than or equal to 20,000 Pa·s, such as less than or equal to 17,500 Pa·s, less than or equal to 15,000 Pa·s, or less than or equal to 12,500 Pa·s. For example, the complex viscosity of the bimodal polyethylene at 190° C. and a frequency of 1.0 rad/s may be from 5,000 Pa·s to 20,000 Pa·s, from 5,000 Pa·s to 17,500 Pa·s, from 5,000 Pa·s to 15,000 Pa·s, from 5,000 Pa·s to 12,500 Pa·s, from 5,000 Pa·s to 10,000 Pa·s, from 5,000 Pa·s to 7,500 Pa·s, from 7,500 Pa·s to 20,000 Pa·s, from 7,500 Pa·s to 17.500 Pa·s, from 7.500 Pa·s to 15,000 Pa·s, from 7,500 Pa·s to 12,500 Pa·s, from 7,500 Pa·s to 10,000 Pa·s, from 10,000 Pa·s to 20,000 Pa·s, from 10,000 Pa·s to 17,500 Pa·s, from 10,000 Pa·s to 15,000 Pa·s, from 12,500 Pa·s to 15,000 Pa·s, from 12,500 Pa·s to 20,000 Pa·s, from 12,500 Pa·s to 17,500 Pa·s, from 12,500 Pa·s to 15,000 Pa·s, from 15,000 Pa·s to 20,000 Pa·s, from 5,000 Pa·s to 17,500 Pa·s, or from 17,500 Pa·s to 20,000 Pa·s.

In one or more embodiments, the complex viscosity of the bimodal polyethylene at 190° C. and a frequency of 10 rad/s is greater than or equal to 1,000 Pa·s, such as greater than or equal to 2,000 Pa·s, greater than or equal to 3,000 Pa·s, or greater than or equal to 4,000 Pa·s. In some embodiments, the complex viscosity of the bimodal polyethylene at 190° C. and a frequency of 10 rad/s is less than or equal to 10,000 Pa·s, such as less than or equal to 9,000 Pa·s, less than or equal to 8,000 Pa·s, or less than or equal to 7,000 Pa·s. For example, the complex viscosity of the bimodal polyethylene at 190° C. and a frequency of 10 rad/s may be from 1,000 Pa·s to 10,000 Pa·s, from 1,000 Pa·s to 9,000 Pa·s, from 1,000 Pa·s to 8,000 Pa·s, from 1,000 Pa·s to 7,000 Pa·s, from 1,000 Pa·s to 6,000 Pa·s, from 1,000 Pa·s to 5,000 Pa·s, from 1,000 Pa·s to 4,000 Pa·s, from 1,000 Pa·s to 3,000 Pa·s, from 1,000 Pa·s to 2,000 Pa·s, from 2,000 Pa·s to 10,000 Pa·s, from 2,000 Pa·s to 9,000 Pa·s, from 2,000 Pa·s to 8,000 Pa·s, from 2,000 Pa·s to 7,000 Pa·s, from 2,000 Pa·s to 6,000 Pa·s, from 2,000 Pa·s to 5,000 Pa·s, from 2,000 Pa·s to 4,000 Pa·s, from 2,000 Pa·s to 3,000 Pa·s, from 3,000 Pa·s to 10,000 Pa·s, from 3,000 Pa·s to 9,000 Pa·s, from 3,000 Pa·s to 8,000 Pa·s, from 3,000 Pa·s to 7,000 Pa·s, from 3,000 Pa·s to 6,000 Pa·s, from 3,000 Pa·s to 5,000 Pa·s, from 3,000 Pa·s to 4,000 Pa·s, from 4,000 Pa·s to 10,000 Pa·s, from 4,000 Pa·s to 9,000 Pa·s, from 4,000 Pa·s to 8,000 Pa·s, from 4,000 Pa·s to 7,000 Pa·s, from 4,000 Pa·s to 6,000 Pa·s, from 4,000 Pa·s to 5,000 Pa·s, from 5,000 Pa·s to 10,000 Pa·s, from 5,000 Pa·s to 9,000 Pa·s, from 5,000 Pa·s to 8,000 Pa·s, from 5,000 Pa·s to 7,000 Pa·s, from 5,000 Pa·s to 6,000 Pa·s, from 6,000 Pa·s to 10,000 Pa·s, from 6,000 Pa·s to 9,000 Pa·s, from 6,000 Pa·s to 8,000 Pa·s, from 6,000 Pa·s to 7,000 Pa·s, from 7,000 Pa·s to 10,000 Pa·s, from 7,000 Pa·s to 9,000 Pa·s, from 7,000 Pa·s to 8,000 Pa·s, from 8,000 Pa·s to 10,000 Pa·s, from 8,000 Pa·s to 9,000 Pa·s, or from 9,000 Pa·s to 10,000 Pa·s.

In one or more embodiments, the complex viscosity of the bimodal polyethylene at 190° C. and a frequency of 100 rad/s is greater than or equal to 500 Pa·s, such as greater than or equal to 800 Pa·s, greater than or equal to 1,100 Pa·s, greater than or equal to 1.400 Pa·s. In some embodiments, the complex viscosity of the bimodal polyethylene at 190° C. and a frequency of 100 rad/s is less than or equal to 2,000 Pa·s, such as less than or equal to 1,700 Pa·s, less than or equal to 1,400 Pa·s, or less than or equal to 1.100 Pa·s. For example, the complex viscosity of the bimodal polyethylene at 190° C. and a frequency of 100 rad/s may be from 500 Pa·s to 2,000 Pa·s, from 500 Pa·s to 1,700 Pa·s, from 500 Pa·s to 1,400 Pa·s, from 500 Pa·s to 1,100 Pa·s, from 500 Pa·s to 800 Pa·s, from 800 Pa·s to 2,000 Pa·s, from 800 Pa·s to 1,700 Pa·s, from 800 Pa·s to 1,400 Pa·s, from 800 Pa·s to 1,100 Pa·s, from 1,100 Pa·s to 2,000 Pa·s, from 1,100 Pa·s to 1,700 Pa·s, from 1,100 Pa·s to 1,400 Pa·s, from 1,400 Pa·s to 2,000 Pa·s, from 1,400 Pa·s to 1,700 Pa·s, or from 1,700 Pa·s to 2,000 Pa·s.

In one or more embodiments, the ratio of the complex viscosity of the bimodal polyethylene at 190° C. and a frequency of 0.1 rad/s to the complex viscosity of the bimodal polyethylene at 190° C. and a frequency of 100 rad/s (i.e., Shear Thinning Index (SHI)) is greater than or equal to 10.0, such as greater than or equal to 12.5, greater than or equal to 15.0, or greater than or equal to 17.5. In some embodiments, the Shear Thinning Index (SHI) of the bimodal polyethylene is less than or equal to 20.0, such as less than or equal to 17.5, less than or equal to 15.0, or less than or equal to 12.5. For example, the Shear Thinning Index (SHI) of the bimodal polyethylene may be from 10.0 to 20.0, from 10.0 to 17.5, from 10.0 to 15.0, from 10.0 to 12.5, from 12.5 to 20.0, from 12.5 to 17.5, from 12.5 to 15.0, from 15.0 to 20.0, from 15.0 to 17.5, or from 17.5 to 20.0. When the shear thinning index (SHI) of the bimodal polyethylene is less than, for example, 10.0, thermoplastic compositions including the bimodal polyethylene may not have adequate processability to manufacture articles, such as, for example, insulation and jacket layers for wires and cables.

As described previously, the bimodal polyethylene may have two primary fractions: a first fraction, which may be a low molecular weight fraction and/or component, and a second fraction, which may be a high molecular weight fraction and/or component. In some embodiments, the bimodal polyethylene has a high molecular weight component and a low molecular weight component. In some embodiments, the bimodal polyethylene includes the high molecular weight component in an amount of from 40 wt. % to 60 wt. %. For example, the bimodal polyethylene may include the high molecular weight component in an amount of from 40 wt. % to 56 wt. %, from 40 wt. % to 52 wt. %, from 40 wt. % to 48 wt. %, from 40 wt. % to 44 wt. %, from 44 wt. % to 60 wt. %, from 44 wt. % to 56 wt. %, from 44 wt. % to 52 wt %, from 44 wt. % to 48 wt. %, from 48 wt. % to 60 wt. %, from 48 wt. % to 56 wt. %, from 48 wt % to 52 wt. %, from 52 wt. % to 60 wt. %, from 52 wt. % to 56 wt %, or from 56 wt. % to 60 wt. %.

In one or more embodiments, the high molecular weight component has a density of from 0.917 g/cm³ to 0.929 g/cm³. For example, the high molecular weight component may have a density of from 0.917 g/cm³ to 0.927 g/cm³, from 0.917 g/cm³ to 0.925 g/cm³, from 0.917 g/cm³ to 0.923 g/cm³, from 0.917 g/cm³ to 0.921 g/cm³, from 0.917 g/cm³ to 0.919 g/cm³, from 0.919 g/cm³ to 0.929 g/cm³, from 0.919 g/cm³ to 0.927 g/cm³, from 0.919 g/cm³ to 0.925 g/cm³, from 0.919 g/cm³ to 0.923 g/cm³, from 0.919 g/cm³ to 0.921 g/cm³, from 0.921 g/cm³ to 0.929 g/cm³, from 0.921 g/cm³ to 0.927 g/cm³, from 0.921 g/cm³ to 0.925 g/cm³, from 0.921 g/cm³ to 0.923 g/cm³, from 0.923 g/cm³ to 0.929 g/cm³, from 0.923 g/cm³ to 0.927 g/cm³, from 0.923 g/cm³ to 0.925 g/cm³, from 0.925 g/cm³ to 0.929 g/cm³, from 0.925 g/cm³ to 0.927 g/cm³, or from 0.927 g/cm³ to 0.929 g/cm³.

In one or more embodiments, the high molecular weight component has a high load melt index (I₂₁) of from 0.85 dg/min to 4.00 dg/min. For example, the high molecular weight component may have a high load melt index (I₂₁) of from 0.85 dg/min to 3.55 dg/min, from 0.85 dg/min to 3.10 dg/min, from 0.85 dg/min to 2.65 dg/min, from 0.85 dg/min to 2.20 dg/min, from 0.85 dg/min to 1.75 dg/min, from 0.85 dg/min to 1.30 dg/min, from 1.30 dg/min to 4.00 dg/min, from 1.30 dg/min to 3.55 dg/min, from 1.30 dg/min to 3.10 dg/min, from 1.30 dg/min to 2.65 dg/min, from 1.30 dg/min to 2.20 dg/min, from 1.30 dg/min to 1.75 dg/min, from 1.75 dg/min to 4.00 dg/min, from 1.75 dg/min to 3.55 dg/min, from 1.75 dg/min to 3.10 dg/min, from 1.75 dg/min to 2.65 dg/min, from 1.75 dg/min to 2.20 dg/min, from 2.20 dg/min to 4.00 dg/min, from 2.20 dg/min to 3.55 dg/min, from 2.20 dg/min to 3.10 dg/min, from 2.20 dg/min to 2.65 dg/min, from 2.65 dg/min to 4.00 dg/min, from 2.65 dg/min to 3.55 dg/min, from 2.65 dg/min to 3.10 dg/min, from 3.10 dg/min to 4.00 dg/min, from 3.10 dg/min to 3.55 dg/min, or from 3.55 dg/min to 4.00 dg/min.

In one or more embodiments, the high molecular weight component has a weight average molecular weight (M_{w(GPC)}) greater than or equal to 200,000 g/mol, such as greater than or equal to 250,000 g/mol, greater than or equal to 300,000 g/mol, or greater than or equal to 350,000 g/mol. In some embodiments, the high molecular weight component has a weight average molecular weight (M_{w(GPC)}) less than or equal to 400,000 g/mol, such as less than or equal to 350,000 g/mol, less than or equal to 300,000 g/mol, or less than or equal to 250,000 g/mol. For example, the high molecular weight component may have a weight average molecular weight (M_{w(GPC)}) of from 200,000 g/mol to 400,000 g/mol, from 200,000 g/mol to 350,000 g/mol, from 200,000 g/mol to 300,000 g/mol, from 200,000 g/mol to 250,000 g/mol, from 250,000 g/mol to 400,000 g/mol, from 250,000 g/mol to 350,000 g/mol, from 250,000 g/mol to 300,000 g/mol, from 300,000 g/mol to 400,000 g/mol, from 300,000 g/mol to 350,000 g/mol, or from 350,000 g/mol to 400,000 g/mol.

In one or more embodiments, the bimodal polyethylene may be a polymerized reaction product of an ethylene monomer and at least one C₃-C₁₂ α-olefin comonomer. For example, embodiments of the bimodal polyethylene composition may be a polymerized reaction product of an ethylene monomer and 1-butene, 1-hexene, or both. Alternatively, embodiments of the bimodal polyethylene composition may be a polymerized reaction product of an ethylene monomer and 1-butene, 1-octene, or both. Embodiments of the bimodal polyethylene may also be a polymerized reaction product of an ethylene monomer and 1-hexene, 1-octene, or both. In some embodiments, the C₃-C₁₂ α-olefin comonomer may not be propylene. That is, the at least one C₃-C₁₂ α-olefin comonomer may be substantially free of propylene. The term “substantially free” of a compound means the material or mixture comprises less than 1.0 wt. % of the compound. For example, the at least one C₃-C₁₂ α-olefin comonomer, which may be substantially free of propylene, may comprise less than 1.0 wt. % propylene, such as less than 0.8 wt. % propylene, less than 0.6 wt. % propylene, less than 0.4 wt. % propylene, or less than 0.2 wt. % propylene.

The bimodal polyethylene may be produced via a variety of methods. Suitable methods may include, for example, gas phase polymerization, slurry phase polymerization, liquid phase polymerization, or combinations of these, using one or more conventional reactors, such as fluidized bed gas phase reactors, loop reactors, stirred tank reactors, batch reactors in parallel, series, or combinations of these. In the alternative, the bimodal polyethylene may be produced in a high-pressure reactor via a coordination catalyst system. For example, the bimodal polyethylene may be produced via gas phase polymerization in a gas phase reactor; however, any of the previously described methods may also be employed. In some embodiments, the system may comprise two or more reactors in series, parallel, or combinations of these, and each polymerization may take place in solution, in slurry, or in the gas phase. In some embodiments, a dual reactor configuration is used and the polymer made in the first reactor can be either the high molecular weight component or the low molecular weight component. The polymer made in the second reactor may have properties (i.e., density, melt index, etc.) such that the desired properties of the bimodal polyethylene are achieved. Similar polymerization processes are described in, for example, U.S. Pat. No. 7,714,072.

In some embodiments, the method for producing the bimodal polyethylene includes polymerizing a high molecular weight component, as previously described, in a reactor, and polymerizing a low molecular weight component, as previously described, in a different reactor. In some embodiments, the two reactors are operated in series. In some embodiments, the high molecular weight component is polymerized in a first reactor, and the low molecular weight component is polymerized in a second reactor. In other embodiments, the low molecular weight component is polymerized in a first reactor, and the high molecular weight component is polymerized in a second reactor.

In some embodiments, the weight ratio of polymer produced in the high molecular weight reactor (i.e., the reactor in which the high molecular weight component is produced) to polymer prepared in the low molecular weight reactor (i.e., the reactor in which the low molecular weight component is produced) is from 30:70 to 70:30. For example, the weight ratio of polymer produced in the high molecular weight reactor to polymer prepared in the low molecular weight reactor may be from 32:68 to 68:32, from 34:66 to 66:34, from 36:64 to 64:36, from 38:62 to 62:38, from 40:60 to 60:40, from 42:58 to 58:42, from 44:56 to 56:44, from 46:54 to 54:46, or from 48:52 to 52:48. As used in the present disclosure, this may also be referred to as a polymer split.

In one or more embodiments, the bimodal polyethylene is produced using at least one Ziegler-Natta (Z-N) catalyst system. In some embodiments, the bimodal polyethylene is produced using multiple reactors in series with a Z-N catalyst being fed to either the first reactor in the series or each reactor in the series. In some embodiments, the Z-N catalyst system may be fed into one or two independently-controlled reactors configured sequentially, and operated in solution, slurry or gas phase. In some embodiments, the Z-N catalyst system may be fed into one or two independently-controlled reactors configured sequentially, and operated in gas phase. Sequential polymerization may be conducted such that fresh catalyst is injected into one reactor, and active catalyst is carried over from the first reactor into the second reactor. The resulting bimodal polyethylene may be characterized as comprising component polymers, each having distinct, unimodal molecular weight distributions (e.g., high and low molecular weight components). As used in the present disclosure, the term “distinct,” when used in reference to the molecular weight distribution of the high molecular weight component and the low molecular weight component, indicates there are two corresponding molecular weight distributions in the resulting GPC curve of the bimodal polyethylene.

As used in the present disclosure, the terms “procatalyst” and “precursor” are used interchangeably and refer to a compound including a ligand, a transition metal, and optionally, an electron donor. The procatalyst may further undergo halogenation by contacting with one or more halogenating agents. A procatalyst can be converted into a catalyst upon activation. Such catalysts are commonly referred to as Ziegler-Natta catalysts. Suitable Zeigler-Natta catalysts are known in the art and include, for example, the catalysts disclosed in U.S. Pat. Nos. 4,302,565; 4,482,687; 4,508,842; 4,990,479; 5,122,494; 5,290,745; and 6,187,866. The term catalyst system refers to a collection of catalyst components, such as procatalyst(s) and cocatalyst(s).

The transition metal compound of the procatalyst composition can include compounds of different kinds. The most usual are titanium compounds—organic or inorganic—having an oxidation degree of 3 or 4. Other transition metals such as, vanadium, zirconium, hafnium, chromium, molybdenum, cobalt, nickel, tungsten and many rare earth metals are also suitable for use in Ziegler-Natta catalysts. The transition metal compound is usually a halide or oxyhalide, an organic metal halide or purely a metal organic compound. In the last-mentioned compounds, there are only organic ligands attached to the transition metal.

In some embodiments, the procatalyst has the formula Mg_{d} Me(OR)ₑX_{f}(ED)_{g} where R is an aliphatic or aromatic hydrocarbon radical having 1 to 14 carbon atoms, or COR′ where R′ is a aliphatic or aromatic hydrocarbon radical having 1 to 14 carbon atoms; each OR group is the same or different; X is independently chlorine, bromine or iodine; ED is an electron donor; d is from 0.5 to 56; e is 0, 1, or 2; f is from 2 to 116; g is from greater than 1 to 1.5(d); and Me is a transition metal selected from the group of titanium, zirconium, hafnium and vanadium. Some specific examples of suitable titanium compounds are: TiCl₃, TiCl₄, Ti(OC₂H₅)₂Br₂, Ti(OC₆H₅)Cl₃, Ti(OCOCH₃)Cl₃, Ti(acetylacetonate)₂Cl₂, TiCl₃(acetylacetonate), and TiBr₄.

The magnesium compounds include magnesium halides such as MgCl₂ (including anhydrous MgCl₂), MgBr₂, and MgI₂. Nonlimiting examples of other suitable compounds are Mg(OR)₂, Mg(OCO₂Et), and MgRCl where R is defined above. From 0.5 to 56 moles, or from 1 to 20 moles of the magnesium compounds are used per mole of transition metal compound. Mixtures of these compounds may also be used.

The procatalyst compound can be recovered as a solid using techniques known in the art, such as precipitation of the procatalyst or by spray drying, with or without fillers. In some embodiments, the procatalyst compound is recovered as a solid via spray drying. Spray drying is taught, for example, in U.S. Pat. No. 5,290,745. A further procatalyst including magnesium halide or alkoxide, a transition metal halide, alkoxide or mixed ligand transition metal compound, an electron donor and optionally, a filler can be prepared by spray drying a solution of said compounds from an electron donor solvent.

The electron donor is typically an organic Lewis base, liquid at temperatures in the range of from 0° C. to 200° C. in which the magnesium and transition metal compounds are soluble. The electron donor can be an alkyl ester of an aliphatic or aromatic carboxylic acid, an aliphatic ketone, an aliphatic amine, an aliphatic alcohol, an alkyl or cycloalkyl ether, or mixtures of these, each electron donor having from 2 to 20 carbon atoms. For example, the electron donor may be alkyl and cycloalkyl mono-ethers having from 2 to 20 carbon atoms; dialkyl, diaryl, and alkylaryl ketones having from 3 to 20 carbon atoms; and alkyl, alkoxy, and alkylalkoxy esters of alkyl and aryl carboxylic acids having from 2 to 20 carbon atoms. As used in the present disclosure, the term mono-ether refers to a compound that contains only one ether functional group in the molecule. Tetrahydrofuran may be a particular suitable electron donor for ethylene homo- and co-polymerization. Other examples of suitable electron donors are methyl formate, ethyl acetate, butyl acetate, ethyl ether, dioxane, di-n-propyl ether, dibutyl ether, ethanol, 1-butanol, ethyl formate, methyl acetate, ethyl anisate, ethylene carbonate, tetrahydropyran, and ethyl propionate.

While an excess of electron donor may be used initially to provide the reaction product of transition metal compound and electron donor, the reaction product finally contains from 1 to 20 moles of electron donor per mole of transition metal compound, or from 1 to 10 moles of electron donor per mole of transition metal compound. The ligands include halogen, alkoxide, aryloxide, acetylacetonate, and amide anions.

Partial activation of the procatalyst can be carried out prior to the introduction of the procatalyst into the reactor. The partially activated catalyst alone can function as a polymerization catalyst but at greatly reduced and commercially unsuitable catalyst productivity. Complete activation by additional cocatalyst is required to achieve full activity. The complete activation occurs in the polymerization reactor via addition of cocatalyst.

The catalyst procatalyst can be used as dry powder or slurry in an inert liquid. The inert liquid is typically a mineral oil. The slurry prepared from the catalyst and the inert liquid has a viscosity measured at 1 sec⁻¹ of at least 500 cp (500 mPa·s) at 20° C. Nonlimiting examples of suitable mineral oils are the Kaydol™ and Hydrobrite™ mineral oils from Crompton.

In some embodiments, the procatalyst undergoes in-line reduction using reducing agent(s). The procatalyst is introduced into a slurry feed tank; the slurry then passes via a pump to a first reaction zone immediately downstream of a reagent injection port where the slurry is mixed with the first reagent, as described subsequently. Optionally, the mixture then passes to a second reaction zone immediately downstream of a second reagent injection port where it is mixed with the second reagent (as described below) in a second reaction zone. While only two reagent injection and reaction zones are described previously, additional reagent injection zones and reaction zones may be included, depending on the number of steps required to fully activate and modify the catalyst to allow control of the specified fractions of the polymer molecular weight distribution. Methods to control the temperature of the catalyst procatalyst feed tank and the individual mixing and reaction zones are provided.

Depending on the activator compound used, some reaction time may be required for the reaction of the activator compound with the catalyst procatalyst. This is conveniently done using a residence time zone, which can consist either of an additional length of slurry feed pipe or an essentially plug flow holding vessel. A residence time zone can be used for both activator compounds, for only one or for neither, depending entirely on the rate of reaction between activator compound and catalyst procatalyst.

Exemplary in-line reducing agents are aluminum alkyls and aluminum alkyl chlorides of the formula AlRₓCl_{y} where X+Y=3 and y is 0 to 2 and R is a C1 to C14 alkyl or aryl radical. Nonlimiting examples of in-line reducing agents include diethylaluminum chloride, ethylaluminum dichloride, di-isobutyaluminum chloride, dimethylaluminum chloride, methylaluminum sesquichloride, ethylaluminum sesquichloride, triethylaluminum, trimethylaluminum, triisobutylaluminum, tri-n-hexylaluminum, tri-n-octylaluminum, and dimethylaluminum chloride.

The entire mixture is then introduced into the reactor where the activation is completed by the cocatalyst. Additional reactors may be sequenced with the first reactor, however, catalyst is typically only injected into the first of these linked, sequenced reactors with active catalyst transferred from a first reactor into subsequent reactors as part of the polymer thus produced.

The cocatalysts, which are reducing agents, conventionally used are comprised of aluminum compounds, but compounds of lithium, sodium and potassium, alkaline earth metals as well as compounds of other earth metals than aluminum are possible. The compounds are usually hydrides, organometal or halide compounds. Conventionally, the cocatalysts are selected from the group comprising Al-trialkyls, AI-alkyl halides, Al-alkyl alkoxides and Al-alkyl alkoxy halides. In particular, Al-alkyls and Al-alkyl chlorides are used. These compounds are exemplified by trimethylaluminum, triethylaluminum, tri-isobutylaluminum, tri-n-hexylaluminum, dimethylaluminum chloride, diethylaluminum chloride, ethylaluminum dichloride and diisobutylaluminum chloride, isobutylaluminum dichloride and the like. Butyllithium and dibutylmagnesium are examples of useful compounds of other metals.

In one or more embodiments, the bimodal polyethylene may be used as a base component to produce a thermoplastic composition. In embodiments, the thermoplastic composition may optionally include one or more additives, such as antistatic agents, colorants, lubricants, pigments, primary antioxidants, secondary antioxidants, processing aids, ultraviolet (UV) stabilizers, UV absorbers, hindered amine stabilizers (HALS), processing aids, surface modifiers, fillers, and/or flame retardants. Suitable UV stabilizers include, for example, carbon black, UVASORB™ HA10 and HA88 (both commercially available from 3V Sigma USA), CHIMASSORB™ 944 LD (commercially available from BASF), and CYASORB® THT 4801, THT 7001, and THT 6460 (each commercially available from Solvay Corp.). The thermoplastic composition may be produced by physically mixing the bimodal polyethylene and any optional additive on the macro level, such as by melt-blending or compounding.

In one or more embodiments, the thermoplastic composition may include the bimodal polyethylene in an amount from 1 wt. % to 99 wt. %. For example, the thermoplastic composition may include the bimodal polyethylene in an amount from 1 wt. % to 90 wt. %, from 1 wt. % to 80 wt. %, from 1 wt. % to 70 wt. %, from 1 wt. % to 60 wt. %, from 1 wt. % to 50 wt. %, from 1 wt. % to 40 wt. %, from 1 wt. % to 30 wt. %, from 1 wt. % to 20 wt. %, from 1 wt. % to 10 wt. %, from 10 wt. % to 99 wt. %, from 10 wt. % to 90 wt. %, from 10 wt. % to 80 wt. %, from 10 wt % to 70 wt %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 99 wt. %, from 20 wt. % to 90 wt. %, from 20 wt. % to 80 wt. %, from 20 wt % to 70 wt. %, from 20 wt. % to 60 wt. %, from 20 wt % to 50 wt %, from 20 wt. % to 40 wt. %, from 20 wt. % to 30 wt %, from 30 wt. % to 99 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt % to 99 wt. %, from 40 wt. % to 90 wt. %, from 40 wt. % to 80 wt %, from 40 wt. % to 70 wt. %, from 40 wt. % to 60 wt. %, from 40 wt. % to 50 wt. %, from 50 wt. % to 99 wt. %, from 50 wt. % to 90 wt. %, from 50 wt % to 80 wt. %, from 50 wt. % to 70 wt. %, from 50 wt. % to 60 wt. %, from 60 wt. % to 99 wt. %, from 60 wt. % to 90 wt. %, from 60 wt. % to 80 wt %, from 60 wt. % to 70 wt. %, from 70 wt. % to 99 wt. %, from 70 wt. % to 90 wt. %, from 70 wt. % to 80 wt. %, from 80 wt. % to 99 wt. %, from 80 wt. % to 90 wt. %, or from 90 wt. % to 99 wt. %.

In one or more embodiments, the thermoplastic composition includes carbon black in an amount of from 0.05 wt. % to 5.00 wt. %. For example, the thermoplastic composition may include carbon black in an amount of from 0.05 wt. % to 4.45 wt. %, from 0.05 wt. % to 3.90 wt. %, from 0.05 wt. % to 3.35 wt. %, from 0.05 wt. % to 2.80 wt. %, from 0.05 wt. % to 2.25 wt %, from 0.05 wt. % to 1.70 wt. %, from 0.05 wt. % to 1.15 wt. %, from 0.05 wt. % to 0.60 wt. %, from 0.60 wt. % to 5.00 wt. %, from 0.60 wt. % to 4.45 wt. %, from 0.60 wt. % to 3.90 wt. %, from 0.60 wt. % to 3.35 wt. %, from 0.60 wt. % to 2.80 wt. %, from 0.60 wt. % to 2.25 wt. %, from 0.60 wt. % to 1.70 wt. %, from 0.60 wt % to 1.15 wt. %, from 1.15 wt. % to 5.00 wt. %, from 1.15 wt. % to 4.45 wt. %, from 1.15 wt % to 3.90 wt. %, from 1.15 wt. % to 3.35 wt. %, from 1.15 wt. % to 2.80 wt. %, from 1.15 wt. % to 2.25 wt. %, from 1.15 wt. % to 1.70 wt. %, from 1.70 wt. % to 5.00 wt. %, from 1.70 wt. % to 4.45 wt. %, from 1.70 wt % to 3.90 wt. %, from 1.70 wt. % to 3.35 wt. %, from 1.70 wt. % to 2.80 wt. %, from 1.70 wt. % to 2.25 wt. %, from 2.25 wt. % to 5.00 wt. %, from 2.25 wt. % to 4.45 wt. %, from 2.25 wt % to 3.90 wt. %, from 2.25 wt. % to 3.35 wt. %, from 2.25 wt. % to 2.80 wt %, from 2.80 wt. % to 5.00 wt. %, from 2.80 wt. % to 4.45 wt. %, from 2.80 wt. % to 3.90 wt. %, from 2.80 wt. % to 3.35 wt. %, from 3.35 wt. % to 5.00 wt. %, from 3.35 wt. % to 4.45 wt. %, from 3.35 wt % to 3.90 wt. %, from 3.90 wt. % to 5.00 wt. %, from 3.90 wt. % to 4.45 wt. %, or from 4.45 wt. % to 5.00 wt. %.

In one or more embodiments, the thermoplastic composition includes a processing aid in an amount of from 0.01 wt. % to 0.40 wt. %. For example, the thermoplastic composition may include a processing aid in an amount of from 0.01 wt. % to 0.27 wt. %, from 0.01 wt. % to 0.14 wt. %, from 0.14 wt. % to 0.40 wt. %, from 0.14 wt. % to 0.27 wt. %, or from 0.27 wt. % to 0.40 wt. %. In some embodiments, the thermoplastic composition includes additional additives (i.e., additives other than carbon black and/or a processing aid), such as a primary antioxidant and/or a secondary antioxidant, in an amount of from 0.05 wt. % to 2.00 wt. %. For example, the thermoplastic composition may include additional additives in an amount of from 0.05 wt. % to 1.75 wt %, from 0.05 wt. % to 1.50 wt. %, from 0.05 wt. % to 1.25 wt. %, from 0.05 wt. % to 1.00 wt. %, from 0.05 wt % to 0.75 wt. %, from 0.05 wt. % to 0.50 wt. %, from 0.05 wt. % to 0.25 wt %, from 0.25 wt. % to 2.00 wt. %, from 0.25 wt. % to 1.75 wt. %, from 0.25 wt. % to 1.50 wt. %, from 0.25 wt. % to 1.25 wt. %, from 0.25 wt. % to 1.00 wt. %, from 0.25 wt. % to 0.75 wt. %, from 0.25 wt % to 0.50 wt. %, from 0.50 wt. % to 2.00 wt. %, from 0.50 wt. % to 1.75 wt. %, from 0.50 wt % to 1.50 wt. %, from 0.50 wt. % to 1.25 wt. %, from 0.50 wt. % to 1.00 wt %, from 0.50 wt. % to 0.75 wt %, from 0.75 wt. % to 2.00 wt. %, from 0.75 wt. % to 1.75 wt. %, from 0.75 wt. % to 1.50 wt. %, from 0.75 wt. % to 1.25 wt. %, from 0.75 wt. % to 1.00 wt. %, from 1.00 wt % to 2.00 wt %, from 1.00 wt. % to 1.75 wt. %, from 1.00 wt. % to 1.50 wt. %, from 1.00 wt. % to 1.25 wt. %, from 1.25 wt. % to 2.00 wt. %, from 1.25 wt. % to 1.75 wt. %, from 1.25 wt. % to 1.50 wt. %, from 1.50 wt. % to 2.00 wt. %, from 1.50 wt. % to 1.75 wt. %, or from 1.75 wt. % to 2.00 wt. %.

The bimodal polyethylene or the thermoplastic composition including the bimodal polyethylene may be used in a wide variety of products and end-use applications. The bimodal polyethylene or the thermoplastic composition including the bimodal polyethylene may also be blended and/or co-extruded with any other polymer. Non-limiting examples of other polymers include linear low density polyethylene, elastomers, plastomers, high pressure low density polyethylene, high density polyethylene, polypropylenes and the like. The bimodal polyethylene, the thermoplastic composition including the bimodal polyethylene, and blends thereof may be used to produce blow molded components or products, among various other end uses. The bimodal polyethylene, the thermoplastic composition including the bimodal polyethylene, and blends thereof may be useful in forming operations such as film, sheet, and fiber extrusion and co-extrusion as well as blow molding, injection molding and rotary molding. Films may include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, and membranes in food-contact and non-food contact applications. Fibers may include melt spinning, solution spinning and melt blown fiber operations for use in woven or non-woven form to make filters, diaper fabrics, medical garments, and geotextiles. Extruded articles may include medical tubing, wire and cable coatings, pipe, geomembranes, and pond liners. Molded articles may include single and multi-layered constructions in the form of bottles, tanks, large hollow articles, rigid food containers and toys.

In one or more embodiments, the bimodal polyethylene, the thermoplastic composition including the bimodal polyethylene, and blends thereof may be used to manufacture a coated conductor. The coated conductor may include a conductive core and a coating layer covering at least a portion of the conductive core. The conductive core may include metallic wire, optical fiber, or combinations thereof. The coating layer may include the bimodal polyethylene, the thermoplastic composition including the bimodal polyethylene, and blends thereof. Electricity, light, or combinations thereof, may be transmitted through the conductive core of the coated conductor. This may be accomplished by applying a voltage across the metallic wire, which may cause electrical energy to flow through the metallic wire, sending a pulse of light (e.g., infrared light) through the optical fiber, which may cause light to transmit through the optical fiber, or combinations thereof.

Environmental stress-cracking resistance is a measure of the strength of an article in terms of its ability to resist failure by stress crack growth. A high environmental stress-cracking resistance value is important because articles should last through the designed application lifetime. In some embodiments, the bimodal polyethylene, the thermoplastic composition including the bimodal polyethylene, or articles manufactured from these may have an environmental stress-cracking resistance (F₀) greater than 1,000 hours, such as greater than 1,500 hours, greater than 2,000 hours, greater than 2,500 hours, greater than 3,000 hours, greater than 3,500 hours, greater than 4,000 hours, or greater than 4,500 hours.

In one or more embodiments, the bimodal polyethylene, the thermoplastic composition including the bimodal polyethylene, or articles manufactured from these have a cyclic shrinkage less than or equal to 2.40%. For example, the bimodal polyethylene, the thermoplastic composition including the bimodal polyethylene, or articles manufactured from these may have a cyclic shrinkage of from 2.00% to 2.40%, from 2.00% to 2.35%, from 2.00% to 2.30%, from 2.00% to 2.25%, from 2.00% to 2.20% from 2.00% to 2.15%, from 2.00% to 2.10%, from 2.00% to 2.05%, from 2.05% to 2.40%, from 2.05% to 2.35%, from 2.05% to 2.30%, from 2.05% to 2.25%, from 2.05% to 2.20%, from 2.05% to 2.15%, from 2.05% to 2.10%, from 2.10% to 2.40%, from 2.10% to 2.35%, from 2.10% to 2.30%, from 2.10% to 2.25%, from 2.10% to 2.20%, from 2.10% to 2.15%, from 2.15% to 2.40%, from 2.15% to 2.35%, from 2.15% to 2.30%, from 2.15% to 2.25%, from 2.15% to 2.20%, from 2.20% to 2.40%, from 2.20% to 2.35%, from 2.20% to 2.30%, from 2.20% to 2.25%, from 2.25% to 2.40%, from 2.25% to 2.35%, from 2.25% to 2.30% from 2.30% to 2.40%, from 2.30% to 2.35%, or from 2.35% to 2.40%.

In one or more embodiments, the bimodal polyethylene, the thermoplastic composition including the bimodal polyethylene, or articles manufactured from these may have a surface smoothness less than 45 μ-in. For example, the bimodal polyethylene, the thermoplastic composition including the bimodal polyethylene, or articles manufactured from these may have a surface smoothness of from 15 μ-in to 45 μ-in, from 15 μ-in to 40 μ-in, from 15 μ-in to 35 μ-in, from 15 μ-in to 30 μ-in, from 15 μ-in to 25 μ-in, from 15 μ-in to 20 μ-in, from 20 μ-in to 45 μ-in, from 20 μ-in to 40 μ-in, from 20 μ-in to 35 μ-in, from 20 μ-in to 30 μ-in, from 20 μ-in to 25 μ-in, from 25 μ-in to 45 μ-in, from 25 μ-in to 40 μ-in, from 25 μ-in to 35 μ-in, from 25 μ-in to 30 μ-in, from 30 μ-in to 45 μ-in, from 30 μ-in to 40 μ-in, from 30 μ-in to 35 μ-in, from 35 μ-in to 45 μ-in, from 35 μ-in to 40 μ-in, or from 40 μ-in to 45 μ-in.

### Test Methods

### Density

Unless indicated otherwise, all densities were measured according to ASTM D792-08, Method B, and are reported in grams per cubic centimeter (g/cm³).

### Melt Index (I₂)

Unless indicated otherwise, all melt indices (I₂) were measured according to ASTM D1238-10, Method B, at 190° C. and a 2.16 kg load, and are reported in decigrams per minute (dg/min).

### High Load Melt Index (I₂₁)

Unless indicated otherwise, all high load melt indices (I₂₁) were measured according to ASTM D1238-10, Method B, at 190° C. and a 21.6 kg load, and are reported in decigrams per minute (dg/min).

### Molecular Weight

Unless indicated otherwise, all molecular weights disclosed herein, including weight average molecular weight (M_{w(GPC)}), number average molecular weight (M_{n(GPC)}), and z-average molecular weight (M_{z(GPC)})), were measured using conventional Gel Permeation Chromatography (GPC) and are reported in grams per mole (g/mol).

The chromatographic system consisted of a PolymerChar GPC-IR (Valencia. Spain) high temperature GPC chromatograph equipped with an internal IR5 infra-red detector (IR5). The autosampler oven compartment was set at 160 degrees Celsius (° C.) and the column compartment was set at 150° C. The columns used were four Agilent “Mixed A” 30-centimeter 20-micron linear mixed-bed columns. The chromatographic solvent used was 1,2,4 trichlorobenzene and contained 200 parts per million (ppm) of butylated hydroxytoluene (BHT). The solvent source was nitrogen sparged. The injection volume used was 200 microliters and the flow rate was 1.0 milliliters per minute (ml/min).

Calibration of the GPC column set was performed with 21 narrow molecular weight distribution polystyrene standards, commercially available from Agilent Technologies, with molecular weights ranging from 580 g/mol to 8,400,000 g/mol and were arranged in six “cocktail” mixtures with at least a decade of separation between individual molecular weights. The polystyrene standards were prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards were dissolved at 80° C. with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} Equation 1

where M is the molecular weight, A has a value of 0.4315, and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at a molecular weight of 120,000 g/mol.

The total plate count of the GPC column set was performed with decane (prepared at 0.04 grams in 50 milliliters of TCB and dissolved for 20 minutes with gentle agitation). The plate count (Equation 2) and symmetry (Equation 3) were measured on a 200 microliter injection according to the following equations:

$$Plate Count = 5.54 * {( \frac{( {RV}_{Peak Max} )}{Peak Width at \frac{1}{2} Height} )}^{2} \qquad Equation 2$$

where RV is the retention volume in milliliters, the peak width is in milliliters, the peak max is the maximum height of the peak, and % height is W height of the peak maximum; and

$$Symmetry = \frac{( Rear Peak {RV}_{One Tenth Hheig} - {RV}_{Peak Max} )}{( {RV}_{Peak Max} - Front Peak {RV}_{One Tent Hei} )} \qquad Equation 3$$

where RV is the retention volume in milliliters and the peak width is in milliliters, peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 milligrams per milliliter (mg/ml), and the solvent (containing 200 ppm BHT) was added to a pre nitrogen-sparged septa-capped vial, via the PolymerChar high temperature autosampler. The samples were dissolved for 2 hours at 160° C. under “low speed” shaking.

The calculations of weight average molecular weight (M_{w(GPC)}), number average molecular weight (M_{n(GPC)}), and z-average molecular weight (M_{z(GPC)}) were based on GPC results using the internal IR5 detector (measurement channel) of the PolymerChar GPC-IR chromatograph according to Equations 4-6, using the PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad Equation 4$$

$${Mw}_{( GPC )} = \frac{{\sum }^{i} ( {IR}_{i} * {M}_{{polyethylene}_{i}} )}{{\sum }^{i} {IR}_{i}} \qquad Equation 5$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad Equation 6$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate_{(Nominal)}) for each sample by RV alignment of the respective decane peak within the sample (RV_{(FM sample)}) to that of the decane peak within the narrow standards calibration (RV_{(FM Calibrated)}). Any changes in the time of the decane marker peak are then assumed to be related to a linear-shift in flowrate (Flowrate_{(Effective)}) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated according to Equation 7. Processing of the flow marker peak was done via the PolymerChar GPCOne™ Software. Acceptable flowrate correction is such that the effective flowrate should be within ±1 percent (%) of the nominal flowrate.

$${Flowrate}_{( Effective )} = {Flowrate}_{( Nomin )} \times ( \frac{{RV}_{( FM Calibrated )}}{{RV}_{( FM Sample )}} ) \qquad Equation 7$$

The Systematic Approach for the determination of multi-detector offsets is done in a manner consistent with that published by Balke, Mourey, et. al. (Mourey and Balke, Chromatography Polym. Chpt 12, (1992)) (Balke. Thitiratsakul, Lew, Cheung, Mourey, Chromatography Polym. Chpt 13, (1992)), optimizing triple detector log (MW and IV) results from a broad homopolymer polyethylene standard (M_{w}/Mₙ>3) to the narrow standard column calibration results from the narrow standards calibration curve using PolymerChar GPCOne™ Software.

The absolute molecular weight data (GPC-LALS) was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from a homopolymer polyethylene standard, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mol, preferably in excess of about 120,000 g/mol.

A calibration for the IR5 detector ratioing was performed using multiple ethylene-based polymer of known short chain branching (SCB) frequency (as determined by NMR), ranging from homopolymer (0 SCB/1000 total C) to approximately 40 SCB/1000 total C, where total C=carbons in backbone+carbons in branches. Each standard had a weight-average molecular weight (M_{W}) from 36,000 g/mol to 126,000 g/mol, as determined by the GPC-LALS processing method described above. Each standard had a molecular weight distribution (Mw/Mn) from 2.0 to 2.5, as determined by the GPC-LALS processing method described hereinabove.

The calculated “IR5 Area Ratio” (or “IR5_{Methyl channel Area}/IR5_{Measurement Channel Area}”) of “the baseline-subtracted area response of the IR5 methyl channel sensor” to “the baseline-subtracted area response of IR5 measurement channel sensor” was calculated for each of the “SCB” standards. A linear fit of the SCB frequency versus the “IR5 Area Ratio” was constructed according to Equation 8 as follows:

$$SCB / 1000 total C ( SCBD ) = {A}_{0} + [ {A}_{1} \times ( \frac{IR {5}_{Methyl Chann Area}}{IR {5}_{Measurement Channel Area}} ) ] \qquad Equation 8$$

where A₀ is the “SCB/1000 total C” intercept at an “IR5 Area Ratio” of zero, and A_{I} is the slope of the “SCB/1000 total C” versus “IR5 Area Ratio” and represents the increase in the SCB/1000 total C as a function of “IR5 Area Ratio.”

The calculations of short chain branching distributions of low molecular weight regions (SCBD₁), short chain branching distributions of high molecular weight regions (SCBD₂), and Comonomer Ratios were based on GPC results using the internal IR5 detector (measurement channel) and the SCB/1000 total C for a bimodal polyethylene. To calculate these values the baseline-subtracted IR chromatogram at equally-spaced data collection points (i) and the SCBD surrounding the maxima of the bimodal resin were determined. The calculation is determined for the polymer at low molecular weight regions (SCBD₁) and high molecular weight regions (SCBD₂) of the polymer distribution. Here in and n, define the molecular weight range at which SCBD₁ is calculated, where m=(Log M 3.75) and n=(Log M 4.25). Here o and p, define the molecular weight range at which SCBD₂ is calculated, where o=(Log M 5.00) and p=(Log M 5.50).

$${SCBD}_{1} = \frac{{\sum }_{m}^{n} ( {IR}_{i} \times {SCBD}_{i} )}{{\sum }_{m}^{n} {IR}_{i}} \qquad Equation 9$$

$${SCBD}_{2} = \frac{{\sum }_{o}^{p} ( {IR}_{i} \times {SCBD}_{i} )}{{\sum }_{o}^{p} {IR}_{i}} \qquad Equation 10$$

The comonomer distribution (also referred to as a comonomer ratio) is defined according to Equation 11. Any value greater than 1.0 is considered a reverse comonomer distribution, a value less than 1.0 is considered a normal comonomer distribution, and a value of 1.0 is considered a flat comonomer distribution.

$$Comonomer Distribution = \frac{{SCBD}_{2}}{{SCBD}_{1}} \qquad Equation 11$$

### Complex Viscosity

Unless indicated otherwise, all complex viscosities (η*) disclosed herein were calculated using Dynamic Mechanical Spectroscopy (DMS) and are reported in pascal-seconds (Pa·s).

Samples were compression-molded into “3 mm thick×1 inch” circular plaques at 350° F., for five minutes, under 25,000 psi pressure, in air. The sample was then taken out of the press, and allowed to cool.

A constant temperature frequency sweep was performed using a TA Instruments “Advanced Rheometric Expansion System (ARES),” equipped with 25 mm (diameter) parallel plates, under a nitrogen purge. Samples were placed on the plate and allowed to melt for five minutes at 190° C. The plates were then closed to a gap of “2 mm,” the samples trimmed (extra sample that extends beyond the circumference of the “25 mm diameter” plate was removed), and then the tests were started. The method had an additional five minute delay built in to allow for temperature equilibrium. The tests were performed at 190° C. over a frequency range of from 0.1 radians per second (rad/s) to 100 rad/s at a constant strain amplitude of 10%.

### Environmental Stress-Cracking Resistance (ESCR)

Unless indicated otherwise, all Environmental Stress-Cracking Resistance (ESCR) values are F₀ failure times reported in hours and were measured according to IEC 60811-406 without oven conditioning.

### Tensile Strength

Unless indicated otherwise, all tensile strength values were measured according to IEC 60811-501 and are reported in megapascals (MPa) and/or pounds per square inch (psi).

### Elongation

Unless indicated otherwise, all elongation values were measured according to IEC 60811-501 and are reported in percent (%).

### Wire Smoothness

Unless indicated otherwise, all wire smoothness values were calculated as an average surface roughness of a coated conductor wire sample (14 American wire gauge (AWG) wire with a 10-15 mm coating thickness) and are reported in microinches (μ-in) and/or microns (μm). The surface roughness values were measured using a Mitutoyo SJ 400 Surface Roughness Tester. Generally, a relatively smoother wire has an average surface roughness less than a relatively rougher wire.

### Flexural Modulus

Unless indicated otherwise, all flexural modulus values were measured according to ISO 178 and are reported in megapascals (MPa).

### Hardness

Unless indicated otherwise, all hardness values were measured according to ISO 868.

### Cyclic Shrinkage

Unless indicated otherwise, all cyclic shrinkage values were measured by cyclic temperature shrinkback testing and are reported in percentage (%). The cyclic temperature shrinkback testing was performed on jacket samples. The jacket samples were conditioned in an oven from 40° C. to 100° C. at a ramp rate of 0.5 degrees Celsius per minute (° C./min), held at 100° C. for 60 minutes, ramped back down to 40° C. at a rate of 0.5° C./min, and held at 40° C. for 20 minutes. This temperature cycle was then repeated four more times, for a total of five cycles. The length of the jacket samples were measured before and after conditions using a ruler precise to 1.6 mm on 61 cm long specimens, and the percent change was determined.

### EXAMPLES

### Production of Bimodal Polyethylene Samples

Bimodal polyethylene samples (i.e., BP-1 to BP-11) were produced via gas phase polymerization using a catalyst system including a procatalyst (UCAT™ J commercially available from Univation Technologies, LLC) and a cocatalyst (triethylaluminum (TEAL)). The procatalyst was partially activated by contact at room temperature with an appropriate amount of a 50% mineral oil solution of tri-n-hexyl aluminum (TNHA). The catalyst slurry was added to a mixing vessel. While stirring, the 50% mineral oil solution of TNHA was added at ratio of 0.17 moles of TNHA to mole of residual THF in the catalyst and stirred for at least 1 hour prior to use. Ethylene (C₂) and 1-hexene (C₆) were polymerized in two fluidized bed reactors. Each polymerization was continuously conducted, after equilibrium was reached, under the respective conditions. Polymerization was initiated in the first reactor by continuously feeding the catalyst and cocatalyst into a fluidized bed of polyethylene granules, together with ethylene, hydrogen, and 1-hexene. The resulting polymer, mixed with active catalyst, was withdrawn from the first reactor, and transferred to the second reactor, using second reactor gas as a transfer medium. The second reactor also contained a fluidized bed of polyethylene granules. Ethylene, hydrogen, and 1-hexene were introduced into the second reactor, where the gases came into contact with the polymer and catalyst from the first reactor. Inert gases, nitrogen and isopentane, made up the remaining pressure in both the first and second reactors. In the second reactor, the cocatalyst was again introduced. The final bimodal polyethylene was continuously removed.

The final bimodal polyethylene of each sample was then compounded with 200 ppm of pentaerythritoltetrakis (3-(3,5-di-tert-butyl-4-hydroxyphenyl)propionate (commercially available as IRGANOX 1010 from BASF) 600 ppm of tris(204-di-tert.-butylphenyl)phosphite (commercially available as IRGAFOS 168 from BASF), and 1000 ppm calcium stearate, and pelletized via a continuous mixer (commercially available as LCM-00 Continuous Mixer from Kobe Steel, Ltd.). The first and second reactor conditions for each sample are reported in Tables 1 and 2.

TABLE 1

| | Sample | | | | | | | | | |
|---|---|---|---|---|---|---|---|---|---|---|
| | BP-1 | | BP-2 | | BP-3 | | BP-4 | | BP-5 | |
| | Reactor | | | | | | | | | |
| | 1 | 2 | 1 | 2 | 1 | 2 | 1 | 2 | 1 | 2 |
| Catalyst | UCAT ™ J | | UCAT ™ J | | UCAT ™ J | | UCAT ™ J | | UCAT ™ J | |
| Temperature (° C.) | 85 | 110 | 85 | 100 | 85 | 110 | 80 | 110 | 80 | 110 |
| Pressure (kPa) | 2392 | 2723 | 2392 | 2710 | 2392 | 2723 | 2393 | 2710 | 2393 | 2717 |
| C₂ Partial Pressure (kPa) | 228 | 662 | 228 | 745 | 200 | 717 | 174 | 592 | 221 | 685 |
| H₂/C₂ Molar Ratio | 0.057 | 1.8 | 0.041 | 1.5 | 0.027 | 1.8 | 0.044 | 1.8 | 0.040 | 1.8 |
| C₆/C₂ Molar Ratio | 0.110 | 0.003 | 0.070 | 0.003 | 0.092 | 0.003 | 0.092 | 0.002 | 0.100 | 0.002 |
| IC5% | 12.0 | 7.0 | 12.0 | 7.0 | 12.0 | 7.9 | 8.0 | 3.0 | 8.1 | 3.0 |
| Cat Feed Rate (cc/hr) | 5.0 | — | 5.4 | — | 5.6 | — | 5.5 | — | 5.8 | — |
| Co-Catalyst | TEAL | TEAL | TEAL | TEAL | TEAL | TEAL | TEAL | TEAL | TEAL | TEAL |
| Co-Catalyst Concentration | 2.5 | 2.5 | 2.5 | 2.5 | 2.5 | 2.5 | 2.5 | 2.5 | 2.5 | 2.5 |
| (wt %) | | | | | | | | | | |
| Co-Catalyst Feed Rate (cc/hr) | 218 | 125 | 235 | 120 | 256 | 120 | 321 | 140 | 305 | 151 |
| Production Weight (kg/hr) | 13.4 | 11.0 | 14.3 | 14.9 | 13.7 | 16.1 | 13.6 | 17.0 | 13.7 | 15.8 |
| Bed Weight (kg) | 42.3 | 68.6 | 39.1 | 72.3 | 39.1 | 74.1 | 42.6 | 65.5 | 42.7 | 66.9 |

| | | | | | |
|---|---|---|---|---|---|
| Split (%) | 55.0 | 49.0 | 46.0 | 44.3 | 46.4 |

TABLE 2

| | Sample | | | | | |
|---|---|---|---|---|---|---|
| | BP-6 | | BP-7 | | BP-8 | |
| | Reactor | | | | | |
| | 1 | 2 | 1 | 2 | 1 | 2 |
| Catalyst | UCAT ™ J | | UCAT ™ J | | UCAT ™ J | |
| Temperature | 80 | 90 | 80 | 90 | 80 | 90 |
| (° C.) | | | | | | |
| Pressure | 2392 | 2713 | 2393 | 2717 | 2393 | 2712 |
| (kPa) | | | | | | |
| C₂ Partial | 217 | 692 | 199 | 736 | 209 | 649 |
| Pressure | | | | | | |
| (kPa) | | | | | | |
| H₂/C₂ Molar | 0.049 | 1.8 | 0.036 | 1.8 | 0.045 | 1.8 |
| Ratio | | | | | | |
| C₆/C₂ Molar | 0.138 | 0.080 | 0.133 | 0.090 | 0.137 | 0.073 |
| Ratio | | | | | | |
| IC5% | 7.9 | 2.9 | 8.0 | 3.0 | 8.0 | 3.0 |
| Cat Feed | 3.8 | — | 4.0 | — | 3.9 | — |
| Rate (cc/hr) | | | | | | |
| Co-Catalyst | TEAL | TEAL | TEAL | TEAL | TEAL | TEAL |
| Co-Catalyst | 2.5 | 2.5 | 2.5 | 2.5 | 2.5 | 2.5 |
| Concentration | | | | | | |
| (wt %) | | | | | | |
| Co-Catalyst | 281 | 140 | 294 | 140 | 292 | 140 |
| Feed Rate | | | | | | |
| (cc/hr) | | | | | | |
| Production | 13.4 | 17.2 | 13.0 | 17.7 | 12.8 | 14.5 |
| Weight | | | | | | |
| (kg/hr) | | | | | | |
| Bed Weight | 40.9 | 65.8 | 40.6 | 64.1 | 42.5 | 63.4 |
| (kg) | | | | | | |
| Split (%) | 43.8 | | 42.3 | | 46.9 | |
| | Sample | | | | | |
| | BP-9 | | BP-10 | | BP-11 | |
| | Reactor | | | | | |
| | 1 | 2 | 1 | 2 | 1 | 2 |
| Catalyst | UCAT ™ J | | UCAT ™ J | | UCAT ™ J | |
| Temperature | 80 | 90 | 80 | 90 | 80 | 90 |
| (° C.) | | | | | | |
| Pressure | 2393 | 2714 | 2393 | 2708 | 2394 | 2720 |
| (kPa) | | | | | | |
| C₂ Partial | 208 | 711 | 203 | 577 | 235 | 726 |
| Pressure | | | | | | |
| (kPa) | | | | | | |
| H₂/C₂ Molar | 0.031 | 1.8 | 0.045 | 1.8 | 0.052 | 1.8 |
| Ratio | | | | | | |
| C₆/C₂ Molar | 0.129 | 0.081 | 0.136 | 0.069 | 0.114 | 0.055 |
| Ratio | | | | | | |
| IC5% | 8.0 | 3.0 | 7.9 | 3.0 | 8.1 | 3.0 |
| Cat Feed | 3.8 | — | 3.8 | — | 5.5 | — |
| Rate (cc/hr) | | | | | | |
| Co-Catalyst | TEAL | TEAL | TEAL | TEAL | TEAL | TEAL |
| Co-Catalyst | 2.5 | 2.5 | 2.5 | 2.5 | 2.5 | 2.5 |
| Concentration | | | | | | |
| (wt %) | | | | | | |
| Co-Catalyst | 290 | 139 | 290 | 140 | 290 | 140 |
| Feed Rate | | | | | | |
| (cc/hr) | | | | | | |
| Production | 13.5 | 17.2 | 13.3 | 13.3 | 13.5 | 13.2 |
| Weight | | | | | | |
| (kg/hr) | | | | | | |
| Bed Weight | 43.1 | 65.5 | 42.6 | 62.2 | 42.6 | 65.2 |
| (kg) | | | | | | |

| | | | |
|---|---|---|---|
| Split (%) | 43.9 | 50.1 | 50.6 |

### Properties of High Molecular Weight Components

Various properties, including high load melt index (I₂₁), density, and weight average molecular weight (M_{w}) of the high molecular weight component of the bimodal polyethylene samples are reported in Table 3. It should be noted that the “high molecular weight component,” as used in the present examples, refers to the portion of the bimodal polyethylene samples produced in the first reactor.

TABLE 3

| | High Load | | Weight Average | |
|---|---|---|---|---|
| | Melt Index (I₂₁) | Density | Molecular Weight | Split |
| Sample | (dg/min) | (g/cm³) | (M_{w(GPC)}) (g/mol) | (wt. %) |
| BP-1 | 1.58 | 0.9281 | 299,402 | 55.0 |
| BP-2 | 1.26 | 0.9262 | 323,810 | 49.0 |
| BP-3 | 0.99 | 0.9222 | 348,587 | 46.0 |
| BP-4 | 1.15 | 0.9234 | 298,726 | 44.3 |
| BP-5 | 1.20 | 0.9232 | 301,948 | 46.4 |
| BP-6 | 2.30 | 0.9181 | 250,506 | 43.8 |
| BP-7 | 1.43 | 0.9178 | 302,447 | 42.3 |
| BP-8 | 2.12 | 0.9181 | 277,847 | 46.9 |
| BP-9 | 1.25 | 0.9182 | 297,575 | 43.9 |
| BP-10 | 2.01 | 0.9182 | 269,948 | 50.1 |
| BP-11 | 2.10 | 0.9220 | 271,267 | 50.6 |

### Properties of Bimodal Polyethylene Samples

Various properties, including molecular weights, short chain branching distributions, and complex viscosities of the bimodal polyethylene samples are reported in Tables 4-7.

TABLE 4

| | (M_{n(GPC)}) | (M_{w(GPC)}) | (M_{z(GPC)}) | (M_{w(GPC)}/ | (M_{z(GPC)}/ | Density | I₂ | I₂₁ | |
|---|---|---|---|---|---|---|---|---|---|
| Sample | (g/mol) | (g/mol) | (g/mol) | M_{n(GPC)}) | M_{w(GPC)}) | (g/cm³) | (dg/min) | (dg/min) | MFR₂₁ |
| BP-1 | 11,775 | 180,231 | 1,246,664 | 15.3 | 6.9 | 0.9497 | 0.47 | 37.1 | 78.8 |
| BP-2 | 12,896 | 180,904 | 1,475,451 | 14.0 | 8.2 | 0.9498 | 0.52 | 40.7 | 78.3 |
| BP-3 | 10,097 | 172,921 | 1,442,351 | 17.1 | 8.3 | 0.9497 | 0.49 | 58.9 | 120.1 |
| BP-4 | 9,387 | 169,151 | 1,180,615 | 18.0 | 7.0 | 0.9498 | 0.50 | 54.3 | 107.8 |
| BP-5 | 9,806 | 171,260 | 1,181,701 | 17.5 | 6.9 | 0.9485 | 0.46 | 46.7 | 101.5 |
| BP-6 | 9,453 | 152,283 | 983,588 | 16.1 | 6.5 | 0.9352 | 0.83 | 69.1 | 82.8 |
| BP-7 | 8,834 | 159,345 | 1,110,674 | 18.0 | 7.0 | 0.9352 | 0.72 | 72.5 | 101.0 |
| BP-8 | 9,282 | 157,037 | 1,045,351 | 16.9 | 6.7 | 0.9353 | 0.66 | 54.4 | 82.0 |
| BP-9 | 8,971 | 171,380 | 1,195,789 | 19.1 | 7.0 | 0.9354 | 0.47 | 45.9 | 97.5 |
| BP-10 | 9,916 | 163,033 | 1,026,995 | 16.4 | 6.3 | 0.9347 | 0.52 | 39.7 | 77.0 |
| BP-11 | 9,936 | 158,776 | 987,882 | 16.0 | 6.2 | 0.9393 | 0.63 | 46.0 | 73.3 |

TABLE 5

| | Maximum | Elongation @ | Hardness, | Flexural |
|---|---|---|---|---|
| | Tensile Strength | Break | 1 s | Modulus |
| Sample | (MPa) | (%) | (Shore D) | (MPa) |
| BP-1 | 41.9 | 921 | 66 | 1160 |
| BP-2 | 40.8 | 934 | 67 | 1120 |
| BP-3 | 38.4 | 884 | 66 | 1170 |
| BP-4 | 37.1 | 670 | 61 | 1207 |
| BP-5 | 35.3 | 634 | 63 | 1154 |
| BP-6 | 32.8 | 686 | 57 | 737 |
| BP-7 | 32.3 | 703 | 57 | 712 |
| BP-8 | 32.7 | 674 | 57 | 756 |
| BP-9 | 33.7 | 692 | 58 | 705 |
| BP-10 | 34.5 | 670 | 57 | 705 |
| BP-11 | 35.8 | 698 | 58 | 837 |

TABLE 6

| | | SCBD of Low Molecular | SCBD of the High Molecular | Comonomer |
|---|---|---|---|---|
| | | Weight Region (SCBD₁) | Weight Region (SCBD₂) | Distribution |
| | | (average branches/1,000 | (average branches/1,000 | (SCBD₂/ |
| Sample | Comonomer | Carbons) | Carbons) | SCBD₁) |
| BP-1 | C₆ | 2.1 | 4.9 | 2.3 |
| BP-2 | C₆ | 2.6 | 5.1 | 2.0 |
| BP-3 | C₆ | 2.5 | 7.6 | 3.0 |
| BP-4 | C₆ | 2.0 | 7.0 | 3.5 |
| BP-5 | C₆ | 3.1 | 7.5 | 2.4 |
| BP-6 | C₆ | 9.4 | 10.9 | 1.2 |
| BP-7 | C₆ | 10.3 | 10.9 | 1.1 |
| BP-8 | C₆ | 9.2 | 11.2 | 1.2 |
| BP-9 | C₆ | 9.5 | 10.4 | 1.1 |
| BP-10 | C₆ | 9.1 | 11.1 | 1.2 |
| BP-11 | C₆ | 6.6 | 8.5 | 1.3 |

TABLE 7

| | Complex | Complex | Complex | Complex | |
|---|---|---|---|---|---|
| | Viscosity | Viscosity | Viscosity | Viscosity | |
| | (η*@ 0.1 | (η*@ 1.0 | (η*@ 10 | (η*@ 100 | Shear Thinning Index (η*@ 0.1 |
| Sample | rad/sec) (Pa · s) | rad/sec) (Pa · s) | rad/sec) (Pa · s) | rad/sec) (Pa · s) | rad/sec/η*@ 100 rad/sec) |
| BP-1 | 22,957 | 13,036 | 5,251 | 1,445 | 15.9 |
| BP-2 | 22,187 | 12,347 | 4,901 | 1,375 | 16.1 |
| BP-3 | 21,902 | 11,503 | 4,256 | 1,110 | 19.7 |
| BP-4 | 23,707 | 12,601 | 4,739 | 1,259 | 18.8 |
| BP-5 | 23,633 | 12,678 | 4,817 | 1,291 | 18.3 |
| BP-6 | 16,464 | 9,739 | 4,071 | 1,192 | 13.8 |
| BP-7 | 19,626 | 10,891 | 4,238 | 1,170 | 16.8 |
| BP-8 | 18,420 | 10,633 | 4,330 | 1,240 | 14.9 |
| BP-9 | 23,671 | 12,682 | 4,777 | 1,282 | 18.5 |
| BP-10 | 20,853 | 11,967 | 4,840 | 1,374 | 15.2 |
| BP-11 | 18,810 | 11,112 | 4,652 | 1,360 | 13.8 |

### Production of Thermoplastic Samples

Thermoplastic samples were prepared by compounding the bimodal polyethylene samples with various additives via a Banbury batch compounding line. The compositions of each thermoplastic sample are reported in Table 8.

TABLE 8

| Sample | T-1 | T-2 | T-3 | T-4 | T-5 | T-6 | T-7 | T-8 | T-9 | T-10 | T-11 |
|---|---|---|---|---|---|---|---|---|---|---|---|
| Bimodal Polyethylene Type | BP-1 | BP-2 | BP-3 | BP-4 | BP-5 | BP-6 | BP-7 | BP-8 | BP-9 | BP-10 | BP-11 |
| Bimodal Polyethylene | 94.08 | 94.08 | 94.08 | 94.08 | 94.08 | 94.01 | 94.01 | 94.01 | 94.01 | 94.01 | 94.01 |
| (wt. %) | | | | | | | | | | | |
| Carbon Black^{a} (wt. %) | 5.60 | 5.60 | 5.60 | 5.60 | 5.60 | 5.67 | 5.67 | 5.67 | 5.67 | 5.67 | 5.67 |
| Antioxidant 1^{b} (wt. %) | 0.15 | 0.15 | 0.15 | 0.15 | 0.15 | 0.15 | 0.15 | 0.15 | 0.15 | 0.15 | 0.15 |
| Antioxidant 2^{c} (wt. %) | 0.15 | 0.15 | 0.15 | 0.15 | 0.15 | 0.15 | 0.15 | 0.15 | 0.15 | 0.15 | 0.15 |
| Processing Aid^{d} (wt. %) | 0.02 | 0.02 | 0.02 | 0.02 | 0.02 | 0.02 | 0.02 | 0.02 | 0.02 | 0.02 | 0.02 |

^{a}Commercially available as AXELERON ™ GP A-0037 BK CPD from the Dow Chemical Company
^{b}Pentaerythritoltetrakis (3-(3,5-di-tert-butyl-4-hydroxyphenyl)propionate (commercially available as IRGANOX ® 1010 from BASF)
^{c}Tris(2,4-di-tert-butylphenyl)phosphite (commercially available as IRGAFOS ® 168 from BASF)
^{d}Commercially available as DYNAMAR ™ FX 5912 from 3M

### Properties of Thermoplastic Samples

Jacket samples were prepared using the thermoplastic samples, as a well as some commercially available thermoplastics. The jacket samples were prepared via extrusion of the thermoplastic onto a conductor using a 6.35 cm (2.5 in) wire extrusion line (commercially available from Davis-Standard). The extrusion line was equipped with a 24:1 L/D barrel and a general polyethylene type screw. The discharge from the extruder flowed through a Guill type 9/32 in×⅝ in adjustable center crosshead and through a tubing tip and coating die to shape the melt flow for the jacket sample fabrication. This equipment was used to generate coated wire samples with a final diameter of approximately 3.2 mm (0.125 in.) and a wall thickness of approximately 0.77 mm (0.03 in) on a 14 AWG solid copper conductor (1.63 mm/0.064 in diameter). The wire extrusion line speed was set to 91 m/min (300 ft/min). The extruder temperature profile was 182° C./193° C./210° C./216° C./227° C./232° C./238° C./238° C. (Die) and the screw speed was adjusted to ˜58 rpm to maintain the line speed and consistent jacket thickness. After extrusion, the jacket samples were conditioned at room temperature for 24 hours before testing. The extrusion conditions, processing performance of the thermoplastic, and various properties of the jacket samples are reported in Tables 9 and 10.

TABLE 9

| | | | | | | Aged | | |
|---|---|---|---|---|---|---|---|---|
| | | | Melt | | | Tensile | Aged Total | Environmental |
| | | Melt | Flow | Tensile | Total | Strength | Elongation | Stress-Cracking |
| | Density | Index (I₂) | Ratio | Strength | Elongation | (MPa) | (%) | Resistance |
| Sample | (g/cm³) | (dg/min) | (MFR₂₁) | (MPa) | (%) | Aged @ 110° C., 14 Days | | (ESCR F0) (hrs) |
| T-1 | 0.961 | 0.43 | 67.4 | 34.0 | 737 | 27.6 | 742 | >3144 |
| T-2 | 0.960 | 0.52 | 74.0 | 33.7 | 812 | 28.9 | 826 | >3048 |
| T-3 | 0.961 | 0.55 | 114.7 | 31.6 | 754 | 27.1 | 725 | >2976 |
| T-4 | 0.961 | 0.52 | 115.5 | 34.8 | 842 | 30.8 | 808 | >3336 |
| T-5 | 0.959 | 0.50 | 92.9 | 36.5 | 848 | 33.9 | 807 | >3336 |
| T-6 | 0.947 | 0.84 | 128.5 | 34.0 | 887 | 30.1 | 932 | >3336 |
| T-7 | 0.947 | 0.76 | 114.6 | 32.5 | 932 | 29.9 | 894 | >3336 |
| T-8 | 0.947 | 0.64 | 85.5 | 34.4 | 875 | 35.0 | 888 | >3168 |
| T-9 | 0.947 | 0.47 | 117.2 | 35.6 | 892 | 31.2 | 865 | >3168 |
| T-10 | 0.949 | 0.52 | 81.9 | 37.9 | 875 | 26.9 | 849 | >3168 |
| T-11 | 0.949 | 0.59 | 73.1 | 36.9 | 906 | 34.3 | 877 | >3168 |
| CE-1^{a} | 0.964 | 0.28 | 79.1 | 31.7 | 785 | 29.2 | 786 | <1608 |
| CE-2^{b} | 0.958 | 0.60 | 67.3 | 33.0 | 1000 | — | — | >2000 |
| CE-3^{c} | 0.954 | 0.75 | 82.6 | 25.3 | 865 | 22.9 | 778 | <96 |
| CE-4^{d} | 0.947 | 0.74 | 87.8 | 32.9 | 1014 | 23.5 | 853 | <168 |
| CE-5^{e} | 0.948 | 0.70 | — | 30.0 | 800 | — | — | >5000 |

^{a}Commercially available as DGDA-1310 BK from the Dow Chemical Company
^{b}Commercially available as BORSTAR ® HE6062 from Borealis AG
^{c}Commercially available as AXELERON ™ FO 6318 BK CPD from the Dow Chemical Company
^{d}Commercially available as AXELERON ™ FO 6548 BK CPD from the Dow Chemical Company
^{e}Commercially available as BORSTAR ® ME6052 from Borealis AG

TABLE 10

| | Line Speed | Melt Temperature | Breaker Plate | Cyclic Shrinkage (%, | Surface Smoothness |
|---|---|---|---|---|---|
| Sample | (ft/min) | (° C.) | Pressure (psi) | 300 fpm) | (μ-in) |
| T-1 | 300 | 251.7 | 2275 | 2.22 | 40 |
| T-2 | 300 | 248.3 | 2190 | 2.22 | 35 |
| T-3 | 300 | 242.8 | 1770 | 2.38 | 20 |
| T-4 | 300 | 245.6 | 1850 | 2.25 | 20 |
| T-5 | 300 | 247.2 | 1970 | 2.25 | 22 |
| T-6 | 300 | 231.1 | 1875 | 2.20 | 22 |
| T-7 | 300 | 230.0 | 1780 | 2.32 | 19 |
| T-8 | 300 | 233.3 | 2070 | 2.22 | 22 |
| T-9 | 300 | 234.4 | 2120 | 2.25 | 21 |
| T-10 | 300 | 238.3 | 2250 | 2.19 | 30 |
| T-11 | 300 | 236.1 | 2250 | 2.22 | 28 |
| CE-1 | 300 | 252.2 | 2350 | 2.35 | 45 |
| CE-2 | 300 | 247.8 | 2300 | 2.86 | 23 |
| CE-3 | 300 | 241.7 | 1860 | — | 22 |
| CE-4 | 300 | 227.8 | 2020 | 2.48 | 35 |
| CE-5 | 300 | 233.9 | 2100 | 2.73 | 36 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 g/cm” is intended to mean “about 40 g/cm³.”

Notations used in the equations included herein refer to their standard meaning as understood in the field of mathematics. For example, “=” means equal to, “x” denotes the multiplication operation, “+” denotes the addition operation, “−” denotes the subtraction operation, “>” is a “greater than” sign, “<” is a “less than” sign, “and “/” denotes the division operation.

Every document cited herein, if any, including any cross-referenced or related patent or patent application and any patent or patent application to which this application claims priority or benefit thereof, is hereby incorporated herein by reference in its entirety unless expressly excluded or otherwise limited. The citation of any document is not an admission that it is prior art with respect to any embodiment disclosed or claimed herein or that it alone, or in any combination with any other reference or references, teaches, suggests or discloses any such embodiment. Further, to the extent that any meaning or definition of a term in this document conflicts with any meaning or definition of the same term in a document incorporated by reference, the meaning or definition assigned to that term in this document shall govern.

1. A bimodal polyethylene comprising a high molecular weight component and a low molecular weight component, wherein the bimodal polyethylene has:
a density of from 0.933 g/cm³ to 0.960 g/cm³ when measured according to ASTM D792-13, Method B;
a melt index (I₂) of from 0.3 dg/min to 0.9 dg/min when measured according to ASTM D1238-10 at 190° C. and a 2.16 kg load; and
a melt flow ratio (MFR₂₁) greater than 70.0, wherein the melt flow ratio (MFR₂₁) is a ratio of a high load melt index (I₂₁) of the bimodal polyethylene to the melt index (I₂), and the high load melt index (I₂₁) is measured according to ASTM D1238-10 at 190° C. and a 21.6 kg load, wherein:
the high molecular weight component has a density of from 0.917 g/cm³ to 0.929 g/cm³ when measured according to ASTM D792-13, Method B
the high molecular weight component has a high load melt index (I₂₁) of from 0.85 dg/min to 4.00 dg/min when measured according to ASTM D1238-10 at 190° C. and a 21.6 kg load; and
the bimodal polyethylene comprises from 40 wt. % to 60 wt. % of the high molecular weight component.

2. The bimodal polyethylene of claim 1, wherein the bimodal polyethylene has a high load melt index (I₂₁) greater than 35.0 dg/min when measured according to ASTM D1238-10 at 190° C. and a 21.6 kg load.

3. The bimodal polyethylene of claim 1, wherein the bimodal polyethylene has a density of from 0.933 g/cm³ to 0.945 g/cm³; and a short chain branching distribution of a high molecular weight region of the bimodal polyethylene (SCBD₂) of the bimodal polyethylene is greater than or equal to 4.0 average number of branches/1000 carbons.

4. The bimodal polyethylene of claim 1, wherein the bimodal polyethylene has a density of from 0.945 g/cm³ to 0.960 g/cm³; and a short chain branching distribution of a high molecular weight region of the bimodal polyethylene (SCBD₂) of the bimodal polyethylene is greater than or equal to 3.0 average number of branches/1000 carbons.

5. The bimodal polyethylene of claim 1, wherein the high molecular weight component has a shear thinning index (SHI) of from 10.0 to 20.0, wherein the a shear thinning index (SHI) is a ratio of a complex viscosity of the bimodal polyethylene measured at 0.1 radians per second (η*0.1) to a complex viscosity of the bimodal polyethylene measured at 100 radians per second (η*100), and the complex viscosities of the bimodal polyethylene are determined at 190° C. using Dynamic Mechanical Spectroscopy (DMS).

6. A method for producing the bimodal polyethylene of claim 1, the method comprising polymerizing ethylene and at least one 1-alkene comonomer in the presence of a catalyst in a multi-reactor system to produce the bimodal polyethylene.

7. The method of claim 6, wherein the ethylene and the at least one 1-alkene comonomer is polymerized via gas-phase polymerization in a dual reactor system.

8. The method of claim 6, wherein the dual reactor system comprises a first gas-phase reactor and a second gas-phase reactor arranged in series; and the high molecular weight component is produced in the first reactor, and the low molecular weight component is produced in the second reactor.

9. The method of claim 6, wherein the at least one 1-alkene comonomer comprises 1-hexene; the catalyst comprises a Ziegler-Natta catalyst; or both.

10. A thermoplastic composition comprising from 1 wt. % to 99 wt. % of the bimodal polyethylene of claim 1; and one or more additives.

11. The thermoplastic composition of claim 10, wherein the one or more additives comprise carbon black.

12. An article manufactured using the thermoplastic composition of claim 10.

13. The article of claim 12, wherein the article is a coated conductor comprising a conductive core; and a coating layer at least partially covering the conductive core, wherein the coating layer comprises the thermoplastic composition of claim 10.

14. The article of claim 12, wherein the thermoplastic composition has a cyclic shrinkage less than or equal to 2.40%; a surface smoothness less than 45 μ-in; or both.

15. The article of claim 12, wherein the thermoplastic composition has an environmental stress-cracking resistance (ESCR) (F₀) greater than 2,500 hours when measured according to IEC 60811-406 without oven conditioning.
